(19) United States
(12) Patent Application Publication
(10) Pub. No.: US 2023/0222581 A1
(43) Pub. Date: Jul. 13, 2023

(54) Reinforcement Learning Based Machine Asset Planning and Management Apparatuses, Processes and Systems

(71) Applicant: FMR LLC, Boston, MA (US)

(72) Inventors: Igor Halperin, Stamford, CT (US); Xiao Zhang, Westwood, MA (US); Jiayu Liu, Winchester, MA (US); Lisa L. Huang, Boston, MA (US)

(21) Appl. No.: 17/832,547

(22) Filed: Jun. 3, 2022

Related U.S. Application Data
(60) Provisional application No. 63/298,624, filed on Jan. 11, 2022.

(51) Int. Cl. G06Q 40/04; G06N 20/00

(52) U.S. Cl. CPC G06Q 40/04; G06N 20/00

(57) ABSTRACT

The Reinforcement Learning Based Machine Asset Planning and Management Apparatuses, Processes and Systems (“MRLAPM”) transforms machine learning training input, order optimization input, withdrawal policy optimization input datastructure/inputs via MRLAPM components into machine learning training output, order optimization output, withdrawal policy optimization output outputs. A machine learning training request datastructure structured to specify a set of agent profile datastructures and an agent sample ranking function is obtained. An agent samples range is determined. A set of inverse reinforcement learning (IRL) training sample datastructures is generated. An optimal reward function having a determined reward function structure is determined using an IRL technique on the set of IRL training sample datastructures. An optimal policy is determined using a reinforcement learning technique and the optimal reward function. An optimal policy datastructure structured to specify parameters that define the structure of the optimal policy is stored.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### PRIORITY CLAIM

Applicant hereby claims benefit to priority under 35 USC § 119 as a non-provisional conversion of: US provisional patent application Ser. No. 63/29 8,624, filed Jan. 11, 2022, entitled “Machine Reinforcement Learning Asset Planning and Management Apparatuses, Processes and Systems”, (attorney docket no. Fidelity0808PV).

The entire contents of the aforementioned applications are herein expressly incorporated by reference.

### FIELD

The present innovations generally address machine learning and database systems, and more particularly, include Reinforcement Learning Based Machine Asset Planning and Management Apparatuses, Processes and Systems.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. § 112.

### BACKGROUND

People own all types of assets, some of which are secured instruments to underlying assets. People have used exchanges to facilitate trading and selling of such assets. Computer information systems, such as NAICO-NET, Trade*Plus and E*Trade allowed owners to trade securities assets electronically.

### BRIEF DESCRIPTION OF THE DRAWINGS

Appendices and/or drawings illustrating various, non-limiting, example, innovative aspects of the Reinforcement Learning Based Machine Asset Planning and Management Apparatuses, Processes and Systems (hereinafter “MRLAPM”) disclosure, include:

FIG. 1 shows non-limiting, example embodiments of an architecture for the MRLAPM;

FIGS. 2A-B show non-limiting, example embodiments of a datagraph illustrating data flow(s) for the MRLAPM;

FIG. 3 shows non-limiting, example embodiments of a logic flow illustrating a machine learning training (MLT) component for the MRLAPM;

FIG. 4 shows non-limiting, example embodiments of a logic flow illustrating an optimized order executing (OOE) component for the MRLAPM;

FIG. 5 shows non-limiting, example embodiments of implementation case(s) for the MRLAPM;

FIG. 6 shows non-limiting, example embodiments of a screenshot illustrating user interface(s) of the MRLAPM;

FIG. 7 shows non-limiting, example embodiments of an architecture for the MRLAPM;

FIG. 8 shows non-limiting, example embodiments of an architecture for the MRLAPM;

FIGS. 9A-B show non-limiting, example embodiments of a datagraph illustrating data flow(s) for the MRLAPM;

FIG. 10 shows non-limiting, example embodiments of a logic flow illustrating a machine learning training (MLT) component for the MRLAPM;

FIG. 11 shows non-limiting, example embodiments of a logic flow illustrating an optimized withdrawal policy generating (OWPG) component for the MRLAPM;

FIG. 12 shows non-limiting, example embodiments of implementation case(s) for the MRLAPM;

FIG. 13 shows non-limiting, example embodiments of a screenshot illustrating user interface(s) of the MRLAPM;

FIG. 14 shows a block diagram illustrating non-limiting, example embodiments of a MRLAPM controller.

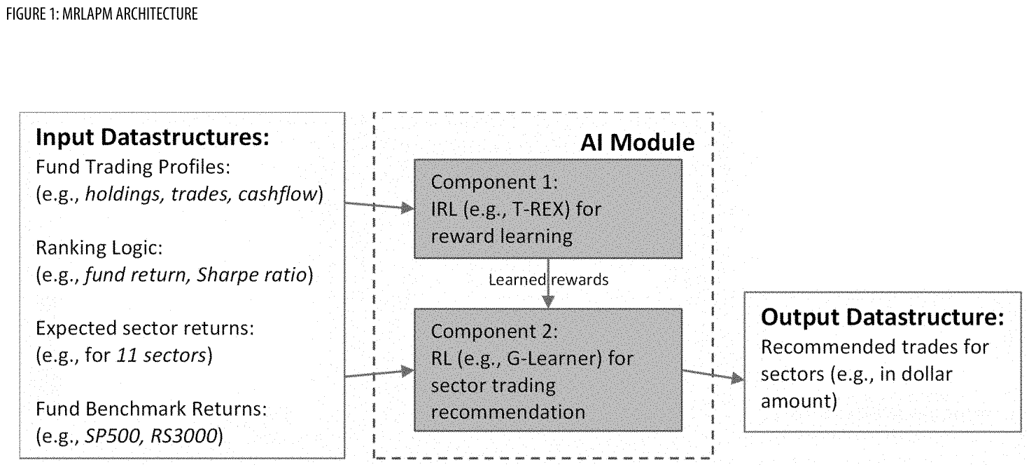

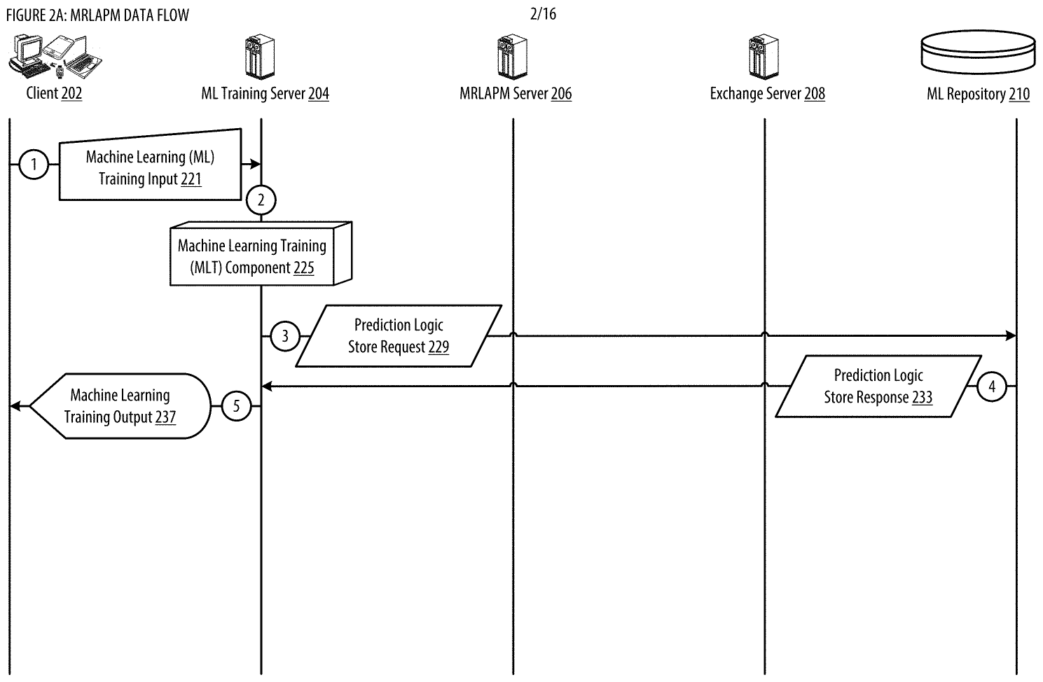

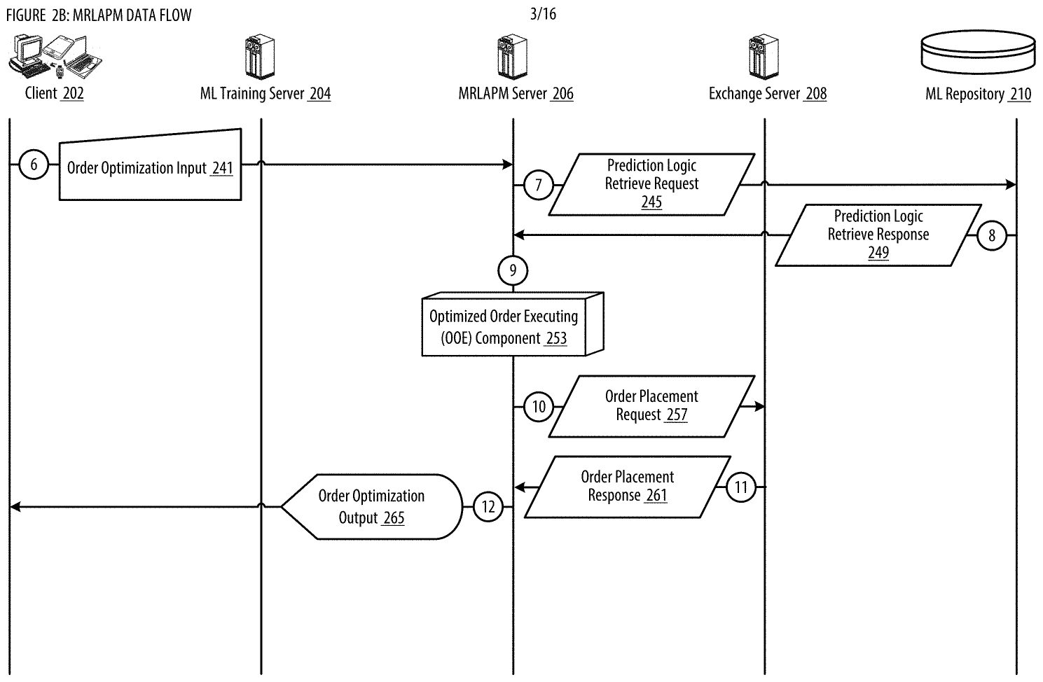

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citations and/or reference numbers are not necessarily sequences but rather just example orders that may be rearranged and other orders are contemplated. Citation number suffixes may indicate that an earlier introduced item has been re-referenced in the context of a later figure and may indicate the same item, evolved/modified version of the earlier introduced item, etc., e.g., server 199 of FIG. 1 may be a similar server 299 of FIG. 2 in the same and/or new context.

### DETAILED DESCRIPTION

The Reinforcement Learning Based Machine Asset Planning and Management Apparatuses, Processes and Systems (hereinafter “MRLAPM”) transforms machine learning training input, order optimization input, withdrawal policy optimization input datastructure/inputs, via MRLAPM components (e.g., MLT, OOE, OWPG, etc. components), into machine learning training output, order optimization output, withdrawal policy optimization output outputs. The MRLAPM components, in various embodiments, implement advantageous features as set forth below.

### INTRODUCTION

The MRLAPM provides unconventional features (e.g., an optimization method that utilizes an IRL technique and an RL technique in combination to create a trade recommender tool/user interface, an optimization method that utilizes an RL technique to create a withdrawal policy recommender tool/user interface) that were never before available in machine learning and database systems.

In one embodiment, the MRLAPM allows people to collaborate with artificial intelligence for better asset management. In one embodiment, MRLAPM provides an efficient mechanism to transform humans' knowledge to machines, e.g., in one arena, this may help humans and machines produce better investment portfolios, but these techniques may apply in many other areas of human to machine intelligence transformations. For example, in one embodiment, the MRLAPM provides an approach that helps improve the mechanisms/processes of dynamic portfolio management by portfolio managers (PMs) by combining their stock picking skills with an optimization method based on Artificial Intelligence (AI). The MRLAPM provides mechanisms/processes of dynamic portfolio management by PMs, e.g., by providing to them a trade recommender tool/user interface. In one example embodiment, the MRLAPM provides never before available and a different IRL algorithm called parametric T-REX, and a different mechanism/method of portfolio aggregation based on, e.g., the industrial sector exposure of the portfolio. This produces a practically useful and efficient algorithm As such, MRLAPM may employ two algorithms that work together. First, MRLAPM may apply a particular version of the T-REX algorithm to learn parameters of the reward function which determines the goals and preferences of a PM or a group of similar PMs. Secondly, this learned reward function may be passed to the second, RL algorithm called the G-Learner, that provides a recommendation to the PM to adjust the portfolio by, e.g., keeping the stocks selected but re-adjusting their weights based on an optimal sector exposure according to the G-learner.

In another embodiment, MRLAPM addresses growing need, e.g., from retirees to have better financial advice in the retirement. For example, investors/retirees may wish to keep more of what they earn; they want life and retirement decisions made as a household across accounts. For such an instance, MRLAPM includes an AI driven mechanism to addresses this problem with the following elements: (a) plan for retirement withdrawals from multiple accounts (e.g., How much do retirees withdrawal from each account annually in a negative-asset-value-force-optimized (e.g., damage, depreciation, destruction, taxes, etc.) way?); How long will the money last (plan length) or say how much money left after a certain plan period?); (b) make sense the withdrawals by taking into consideration of market return changes and different account negative-asset-value-force treatments/restrictions (e.g., required minimum distribution (RMD)); (c) satisfy varied customer need/lifestyle (e.g., bequest, varied after-negative-asset-value-force minimum annual withdrawals, longevity, etc.). In one embodiment, the MRLAPM facilitates delivery of an investment solution built from Voice of Our Customer. It also improves quality of personalized planning recommendations about clients' financial goal. And it also may automate the advisory process along clients' financial journey. In one embodiment, MRLAPM includes a first reinforcement learning based negative-asset-value-force efficient withdrawal optimization mechanism (e.g., model, with the integration of all necessary regulatory rules), financial market changes as well as flexible clients financial goals. As such, MRLAPM provides the first retirement planning advisory system that has discretion to move money between accounts and allow clients to share forward looking market views in the plan. As such, MRLAPM includes some never before available features including: (a) formulated the retirement planning problem in a RL framework by modeling financial market as environment, retirement account withdrawal location as agent, and regulatory rules, negative-asset-value-force cost, clients' level of satisfaction as rewards; (b) provides intermediate rewards and terminal rewards to model multiple financial goals of clients; (c) designs financial market scenarios to model future market changes and allow clients' inputs of their views; and (d) implemented the RL-based system through paralleled computing.

MRLAPM

FIG. 1 shows non-limiting, example embodiments of an architecture for the MRLAPM. In FIG. 1, an embodiment of how a set of input datastructures and an AI module may be utilized to generate a prediction logic output datastructure is illustrated. In one implementation, the set of input datastructures may include fund trading profiles (e.g., holdings, trades, cashflow) for a set of funds (e.g., which utilize the same fund benchmark, such as the S&P 500 index), a ranking logic that ranks fund performance (e.g., fund return, Sharpe ratio, Sortino ratio), expected sector returns (e.g., for the 11 S&P 500 sectors), fund benchmark (e.g., S&P 500 index, Russell 3000 index) returns, and/or the like. In one implementation, the AI module may include a first component that utilizes an inverse reinforcement learning (IRL) technique (e.g., T-REX) for learning a reward function, and a second component that utilizes a reinforcement learning (RL) technique (e.g., G-Learner) and the learned reward function for learning an optimal policy that provides sector trading recommendations. In one implementation, the prediction logic output datastructure may store the learned optimal policy and may be used to recommend trades for sectors (e.g., in dollar amounts).

FIGS. 2A-B show non-limiting, example embodiments of a datagraph illustrating data flow(s) for the MRLAPM. In FIGS. 2A-B, a client 202 (e.g., of a user) may send a machine learning (ML) training input 221 to a ML training server 204 to facilitate training a prediction logic using a machine learning technique. For example, the client may be a desktop, a laptop, a tablet, a smartphone, a smartwatch, and/or the like that is executing a client application. In one implementation, the ML training input may include data such as a request identifier, IRL technique details, RL technique details, configuration parameters for the ML techniques, a set of agent profile datastructures, an agent sample ranking function, buckets, expected bucket (e.g., sector) returns, a benchmark, and/or the like. In one embodiment, the client may provide the following example ML training input, substantially in the form of a (Secure) Hypertext Transfer Protocol (“HTTP(S)”) POST message including eXtensible Markup Language (“XML”) formatted data, as provided below:

```
POST /authrequest.php HTTP/1.1
Host: www.server.com
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
      <user_account_credentials>
          <user_name>JohnDaDoeDoeDoooe@gmail. com</user_name>
          <password>abc123</password>
          //OPTIONAL <cookie>cookieID</cookie>
          //OPTIONAL <digital_cert_link>www. mydigitalcertificate. com/
JohnDoeDaDoeDoe@gmail.com/mycertifcate.dc</digital_cert_link>
          //OPTIONAL <digital_certificate>_DATA_</digital_certificate>
      </user_account_credentials>
  </user_accounts_details>
  <client_details> //iOS Client with App and Webkit
          //it should be noted that although several client details
          //sections are provided to show example variants of client
          //sources, further messages will include only on to save
          //space
      <client_IP>10.0.0.123</client_IP>
      <user_agent_string>Mozilla/5.0 (iPhone; CPU iPhone OS 7_1_1 like Mac OS X)
AppleWebKit/537.51.2 (KHTML, like Gecko) Version/7.0 Mobile/11D201
Safari/9537.53</user_agent_string>
      <client_product_type>iPhone6jl</client_product_type>
      <client_serial_number>DNXXXlXlXXXX</client_serial_number>
      <client_UDID>3XXXXXXXXXXXXXXXXXXXXXXXXD</client_UDID>
      <client_OS>iOS</client_OS>
      <client_OS_version>7.1.1</client_OS_version>
      <client_app_type>app with webkit</client_app_type>
      <app_installed_flag>true</app_installed_flag>
      <app_name>MRLAPM.app</app_name>
      <app_version>1.0 </app_version>
      <app_webkit_name>Mobile Safari</client_webkit_name>
      <client_version>537.51.2</client_version>
  </client_details>
  <client_details> //iOS Client with Webbrowser
      <client_IP>10.0.0.123</client_IP>
      <user_agent_string>Mozilla/5.0 (iPhone; CPU iPhone OS 7_1_1 like Mac OS X)
AppleWebKit/537.51.2 (KHTML, like Gecko) Version/7.0 Mobile/11D201
Safari/9537.53</user_agent_string>
      <client_product_type>iPhone6jl</client_product_type>
      <client_serial_number>DNXXX1X1XXXX</client_serial_number>
      <client_UDID>3XXXXXXXXXXXXXXXXXXXXXXXXD</client_UDID>
      <client_OS>iOS</client_OS>
      <client_OS_version>7.1.l</client_OS_version>
      <client_app_type>web browser</client_app_type>
      <client_name>Mobile Safari</client_name>
      <client_version>9537.53</client_version>
  </client_details>
  <client_details> //Android Client with Webbrowser
      <client_IP>10.0.0.123</client_IP>
      <user_agent_string>Mozilla/5.0 (Linux; U; Android 4.0.4; en-us; Nexus S
Build/IMM76D) AppleWebKit/534.30 (KHTML, like Gecko) Version/4.0 Mobile
Safari/534.30</user_agent_string>
      <client_product_type>Nexus S</client_product_type>
      <client_serial_number>YXXXXXXXXZ</client_serial_number>
      <client_UDID>FXXXXXXXXX-XXXX-XXXX-XXXX-XXXXXXXXXXXXX</client_UDID>
      <client_OS>Android</client_OS>
      <client_OS_version>4.0.4</client_OS_version>
      <client_app_type>web browser</client_app_type>
      <client_name>Mobile Safari</client_name>
      <client_version>534.30</client_version>
  </client_details>
  <client_details> //Mac Desktop with Webbrowser
      <client_IP>10.0.0.123</client_IP>
      <user_agent_string>Mozilla/5.0 (Macintosh; Intel Mac OS X 10_9_3)
AppleWebKit/537.75.14 (KHTML, like Gecko) Version/7.0.3
Safari/537.75.14</user_agent_string>
      <client_product_type>MacPro5jl</client_product_type>
      <client_serial_number>YXXXXXXXXZ</client_serial_number>
      <client_UDID>FXXXXXXXXX-XXXX-XXXX-XXXX-XXXXXXXXXXXXX</client_UDID>
      <client_OS>Mac OS X</client_OS>
      <client_OS_version>10.9.3</client_OS_version>
      <client_app_type>web browser</client_app_type>
      <client_name>Mobile Safari</client_name>
      <client_version>537.75.14</client_version>
  </client_details>
    <machine_learning_training_input>
    <request_identifier>ID_request_l</request_identifier>
    <IRL_technique_identifier>ID_T-REX</IRL_technique_identifier>
    <RL_technique_identifier>ID_G-Learner</RL_technique_identifier>
    <agent_profiles>
      <agent_profile>
        <fund_alias>ID_fund_l</fund_alias>
        <fund_data>
          ^{<}year_month>2017-08</year_month>
          <sector Communication Services</sector>
          <holdings>1.111e+08</holdings>
          <trades>-7974684.75</trades>
          <cashflow>-6682420.5</cashflow>
        </fund_data>
        <fund_data>
          <year_month>2017-08</year_month>
          <sector>Consumer Discretionary</sector>
          <holdings>3.449e+07</holdings>
          <trades>2333109.1</trades>
          <cashflow>-6682420.5</cashflow>
        </fund_data>
        <fund_data>
          <year_month>2017-08</year_month>
          <sector >Industrials</sector>
          . . .
        </fund_data>
        <fund_data>
          <year_month>2017-08</year_month>
          <sector>Information Technology</sector>
          . . .
        </fund_data>
        . . .
        <fund_data>
          <year_month>2019-12</year_month>
          <sector Communication Services</sector>
          <holdings>1.222e+08</holdings>
          <trades>-6864684.75</trades>
          <cashflow>-5572420.5</cashflow>
        </fund_data>
        <fund_data>
          <year_month>2019-12</year_month>
          <sector>Consumer Discretionary</sector>
          <holdings>2.338e+07</holdings>
          <trades>1223109.1</trades>
          <cashflow>-5572420.5</cashflow>
        </fund_data>
        <fund_data>
          <year_month>2019-12</year_month>
          <sector>Industrials</sector>
          . . .
        </fund_data>
        <fund_data>
          ^{<}year_month>2019-12</year_month>
          <sector>Information Technology</sector>
          . . .
        </fund_data>
          . . .
      </agent_profile>
      . . .
      <agent_profile>
        <fund_alias>ID_fund_4</fund_alias>
        <fund_data>
          <year_month>2017-08</year_month>
          <sector Communication Services</sector>
          . . .
        </fund_data>
        <fund_data>
          <year_month>2017-08</year_month>
          <sector>Consumer Discretionary</sector>
          . . .
        </fund_data>
        <fund_data>
          <year_month>2017-08</year_month>
          <sector>Industrials</sector>
          . . .
          <holdings>3.381e+08</holdings>
          <trades>1656227.8</trades>
          <cashflow>-40588208</cashflow>
        </fund_data>
        <fund_data>
          <year_month>2017-08</year_month>
          <sector>Information Technology</sector>
          <holdings>1.956e+08</holdings>
          <trades>-2428437.5</trades>
          <cashflow>-40588208</cashflow>
        </fund_data>
        . . .
        <fund_data>
          <year_month>2019-12</year_month>
          <sector Communication Services</sector>
        </fund_data>
        <fund_data>
          <year_month>2019-12</year_month>
          <sector>Consumer Discretionary</sector>
        </fund_data>
        <fund_data>
          <year_month>2019-12</year_month>
          <sector>Industrials</sector>
          <holdings>4.492e+08</holdings>
          <trades>2766227.8</trades>
          <cashflow>-51688208</cashflow>
        </fund_data>
        <fund_data>
          <year_month>2019-12</year_month>
          <sector>Information Technology</sector>
          <holdings>2.067e+08</holdings>
          <trades>-3538437.5</trades>
          <cashflow>-51688208</cashflow>
        </fund_data>
            . . .
          </agent_profile>
          . . .
    </agent_profiles>
    <agent_sample_ranking_function>FUND_RETURN</agent_sample_ranking_function>
    < buckets >SP500_SECTORS</buckets>
    <expected_sector_returns>DEFAULT_SP500_SECTOR_RETURNS</expected_sector_returns>
    <benchmark>SP500</benchmark>
  </machine_learning_training_input>
</auth_request>
```

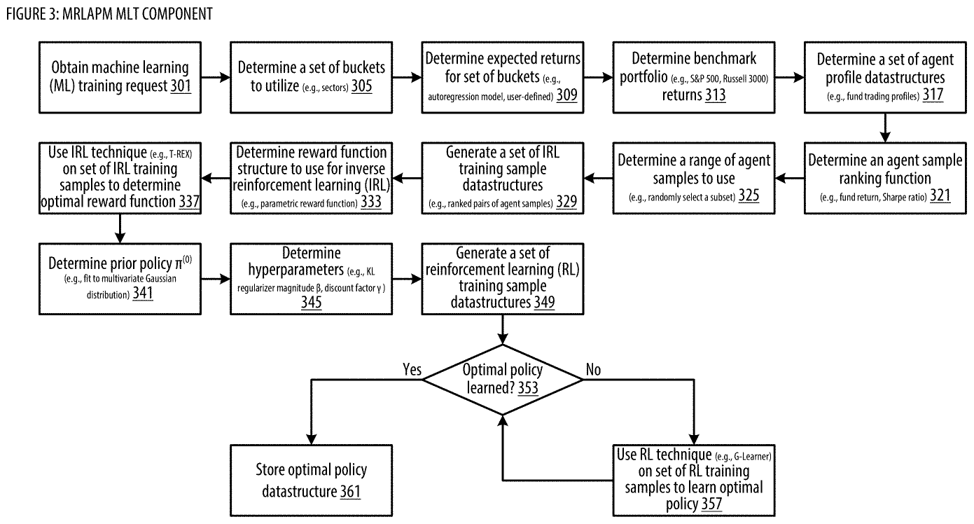

A machine learning training (MLT) component 225 may utilize data provided in the ML training input to train a prediction logic that provides trading recommendations. See FIG. 3 for additional details regarding the MLT component.

The ML training server 204 may send a prediction logic store request 229 to a ML repository 210 to store the trained prediction logic. In one implementation, the prediction logic store request may include data such as a request identifier, a request type, a prediction logic identifier, prediction logic trained structure, and/or the like. In one embodiment, the ML training server may provide the following example prediction logic store request, substantially in the form of a HTTP(S) POST message including XML-formatted data, as provided below:

```
POST /prediction_logic_store_request.php HTTP/1.1
Host: www.server.com
Content-Type: Application/XML
Content-Length: 667
<?XML version = “1.0” encoding = “UTF-8”?>
<prediction_logic_store_request>
  <request_identifier>ID_request_2</request_identifier>
  <request_type>STORE</request_type>
  <prediction_logic_identifier>ID_prediction_logic_1</prediction_logic_identifier>
  <prediction_logic_trained_structure>
    optimaL poLicy π datastructure
  </prediction_logic_trained_structure>
</prediction_logic_store_request>
```

The ML repository 210 may send a prediction logic store response 233 to the ML training server 204 to confirm that the trained prediction logic was stored successfully. In one implementation, the prediction logic store response may include data such as a response identifier, a status, and/or the like. In one embodiment, the ML repository may provide the following example prediction logic store response, substantially in the form of a HTTP(S) POST message including XML-formatted data, as provided below:

```
POST /prediction_logic_store_response.php HTTP/1.1
Host: www.server.com
Content-Type: Application/XML
Content-Length: 667
<?XML version = “1.0” encoding = “UTF-8”?>
<prediction_logic_store_response>
  <response_identifier>ID_response_2</response_identifier>
  <status>OK</status>
</prediction_logic_store_response>
```

The ML training server 204 may send a machine learning training output 237 to the client 202 to inform the user that training was completed successfully. In one implementation, the machine learning training output may include data such as a response identifier, a status, and/or the like. In one embodiment, the ML training server may provide the following example machine learning training output, substantially in the form of a HTTP(S) POST message including XML-formatted data, as provided below:

```
POST /machine_learning_training_output.php HTTP/1.1
Host: www.server.com
Content-Type: Application/XML
Content-Length: 667
<?XML version = “1.0” encoding = “UTF-8”?>
<machine_learning_training_output>
  <response_identifier>ID_response_1</response_identifier>
  <status>OK</status>
</machine_learning_training_output>
```

The client 202 (e.g., the same client of the user who initiated the training of the prediction logic, a different client of a different user who utilizes the trained prediction logic) may send an order optimization input 241 to a MRLAPM server 206 to facilitate placing an order with optimal order parameters. In one implementation, the order optimization input may include data such as a request identifier, a prediction logic identifier, an order constraint value, holdings for a set of buckets, and/or the like. In one embodiment, the client may provide the following example order optimization input, substantially in the form of a HTTP(S) POST message including XML-formatted data, as provided below:

```
POST /order_optimization_input.php HTTP/1.1
Host: www.server.com
Content-Type: Application/XML
Content-Length: 667
<?XML version = “1.0” encoding = “UTF-8”?>
<order_optimization_input>
  <request_identifier>ID_request_3</request_identifier>
  <prediction_logic_identifier>ID_prediction_logic_1</prediction_logic_identifier>
  <cashflow>−6682420.5</cashflow>
  <buckets>
    <bucket>
      <sector>Communication Services</sector>
      <holdings>1.111e+08</holdings>
    </bucket>
    <bucket>
      <sector>Consumer Discretionary</sector>
      <holdings>3.449e+07</holdings>
    </bucket>
    ...
  </buckets>
</order_optimization_input>
```

The MRLAPM server 206 may send a prediction logic retrieve request 245 to the ML repository 210 to retrieve a trained prediction logic. In one implementation, the prediction logic retrieve request may include data such as a request identifier, a request type, a prediction logic identifier, and/or the like. In one embodiment, the MRLAPM server may provide the following example prediction logic retrieve request, substantially in the form of a HTTP(S) POST message including XML-formatted data, as provided below:

```
POST /prediction_logic_retrieve_request.php HTTP/1.1
Host: www.server.com
Content-Type: Application/XML
Content-Length: 667
<?XML version = “1.0” encoding = “UTF-8”?>
<prediction_logic_retrieve_request>
  <request_identifier>ID_request_4</request_identifier>
  <request_type>RETRIEVE</request_type>
  <prediction_logic_identifier>ID_prediction_logic_1</prediction_logic_identifier>
</prediction_logic_retrieve_request>
```

The ML repository 210 may send a prediction logic retrieve response 249 to the MRLAPM server 206 with the requested trained prediction logic. In one implementation, the prediction logic retrieve response may include data such as a response identifier, the requested prediction logic trained structure, and/or the like. In one embodiment, the ML repository may provide the following example prediction logic retrieve response, substantially in the form of a HTTP(S) POST message including XML-formatted data, as provided below:

```
POST /prediction_logic_retrieve_response.php HTTP/1.1
Host: www.server.com
Content-Type: Application/XML
Content-Length: 667
<?XML version = “1.0” encoding = “UTF-8”?>
<prediction_logic_retrieve_response>
  <response_identifier>ID_response_4</response_identifier>
  <prediction_logic_trained_structure>
    optimaL poLicy π datastructure
  </prediction_logic_trained_structure>
</prediction_logic_retrieve_response>
```

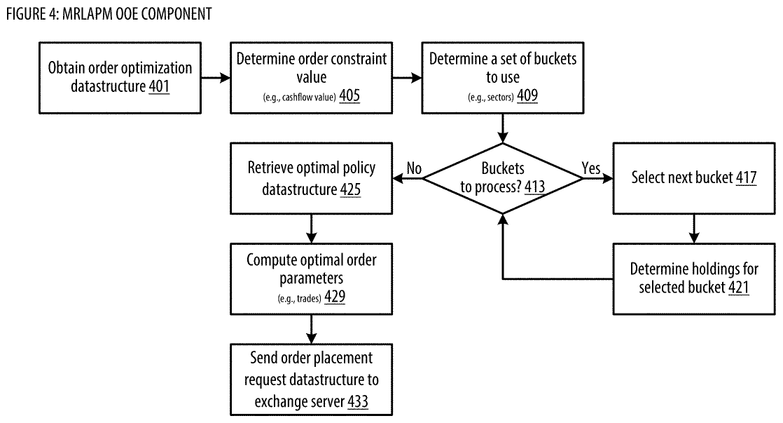

An optimized order executing (OOE) component 253 may utilize the retrieved prediction logic to compute optimal order parameters and/or to place an order with the optimal order parameters. See FIG. 4 for additional details regarding the OOE component.

The MRLAPM server 206 may send an order placement request 257 to an exchange server 208 to facilitate placing the order with the optimal order parameters. For example, one or more order placement requests may be sent (e.g., over time) to one or more exchange servers (e.g., for one or more venues) in accordance with the optimal order parameters. In one implementation, the order placement request may include data such as a request identifier, order details, and/or the like. In one embodiment, the MRLAPM server may provide the following example order placement request, substantially in the form of a HTTP(S) POST message including XML-formatted data, as provided below:

```
POST /order_placement_request.php HTTP/1.1
Host: www.server.com
Content-Type: Application/XML
Content-Length: 667
<?XML version = “1.0” encoding = “UTF-8”?>
<order_placement_request>
  <request_identifier>ID_request_5</request_identifier>
  <order_details>
    <action>BUY</action>
    < sector>Communication Services</sector>
    <quantity>8.625133e+06</quantity>
  </order_details>
  <order_details>
    <action>BUY</action>
    <sector>Consumer Discretionary</sector>
    <quantity>3.409290e+06</quantity>
  </order_details>
  <order_details>
    <action>SELL</action>
    <sector>Consumer Staples</sector>
    <quantity>5.921431e+06</quantity>
  </order_details>
  ...
</order_placement_request>
```

The exchange server 208 may send an order placement response 261 to the MRLAPM server 206 to confirm that the order was placed successfully. In one implementation, the order placement response may include data such as a response identifier, a status, and/or the like. In one embodiment, the exchange server may provide the following example order placement response, substantially in the form of a HTTP(S) POST message including XML-formatted data, as provided below:

```
POST /order_placement_response.php HTTP/1.1
Host: www.server.com
Content-Type: Application/XML
Content-Length: 667
<?XML version = “1.0” encoding = “UTF-8”?>
<order_placement_response>
  <response_identifier>ID_response_5</response_identifier>
  <status>OK</status>
</order_placement_response>
```

The MRLAPM server 206 may send an order optimization output 265 to the client 202 to inform the user that the order was placed successfully. In one implementation, the order optimization output may include data such as a response identifier, a status, and/or the like. In one embodiment, the MRLAPM server may provide the following example order optimization output, substantially in the form of a HTTP(S) POST message including XML-formatted data, as provided below:

```
POST /order_optimization_output.php HTTP/1.1
Host: www.server.com
Content-Type: Application/XML
Content-Length: 667
<?XML version = “1.0” encoding = “UTF-8”?>
<order_optimization_output>
  <response_identifier>ID_response_3</response_identifier>
  <status>OK</status>
</order_optimization_output>
```

FIG. 3 shows non-limiting, example embodiments of a logic flow illustrating a machine learning training (MLT) component for the MRLAPM. In FIG. 3, a machine learning (NIL) training request may be obtained at 301. For example, the ML training request may be obtained as a result of a user initiating training of a prediction logic that provides trading recommendations.

A set of buckets to utilize may be determined at 305. For example, buckets may correspond to the 11 sectors of the S&P 500 index that correspond to the following indexes:

[‘SP500CD’, ‘Consumer Discretionary’],
[‘SP500CS’, ‘Consumer Staples’],
[‘SP500EN’, ‘Energy’],
[‘SP500FN’, ‘Financials’],
[‘SP500IN’, ‘Industrials’],
[‘SP500IT’, ‘Information Technology’],
[‘SP500MT’, ‘Materials’],
[‘SP500RE’, ‘Real Estate’],
[‘SP500TC’, ‘Communication Services’],
[‘SP500UT’, ‘Utilities’],
[‘SP500HC’, ‘Health Care’]

In one implementation, the ML training request may be parsed (e.g., using PHP commands) to determine the set of buckets to use (e.g., based on the value of the buckets field).

Expected returns for the set of buckets may be determined at 309. In one embodiment, the expected returns for the set of buckets may be determined using a pre-trained (e.g., autoregression) structure. For example, an autoregressive moving average (ARMA) model may be utilized to compute default values of the expected sector returns rₜ and the regression residue may then be used to estimate the sector return covariance matrix Σᵣ. In another embodiment, the expected returns for the set of buckets may be user-defined. For example, the user may provide estimated expected sector returns. In one implementation, the ML training request may be parsed (e.g., using PHP commands) to determine the expected returns for the set of buckets (e.g., based on the value of the expected_sector_returns field).

Benchmark portfolio returns may be determined at 313. For example, a benchmark portfolio may be S&P 500, Russell 3000, and/or the like. In one embodiment, the benchmark portfolio returns may be determined for a certain training period (e.g., 2 years, from January 2017 to December 2018). In one implementation, the ML training request may be parsed (e.g., using PHP commands) to determine the benchmark portfolio (e.g., based on the value of the benchmark field), and the returns for the benchmark portfolio may be determined (e.g., from publically available data).

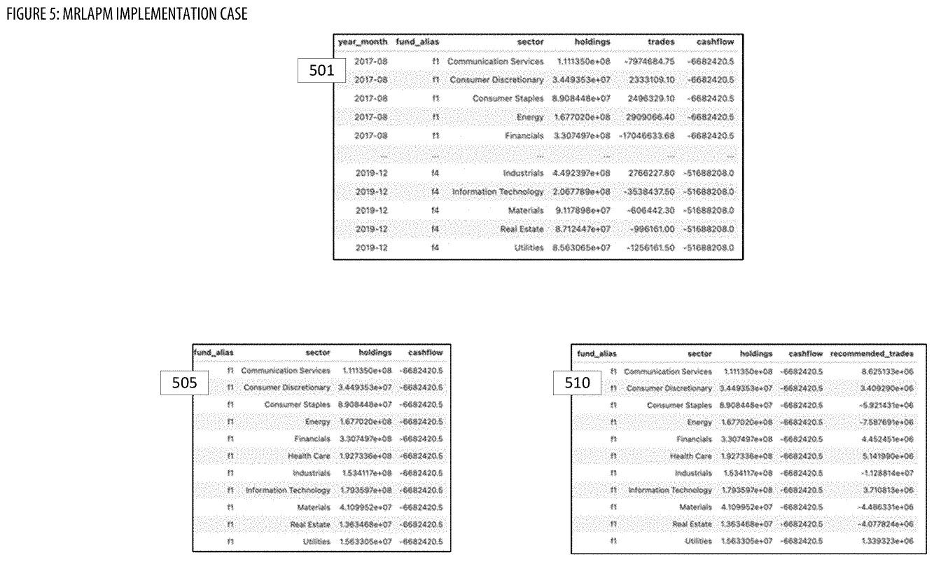

A set of agent profile datastructures may be determined at 317. For example, an agent profile datastructure of an agent may correspond to a fund trading profile of a fund and may include the agent's (e.g., the fund's) monthly holdings, trades and cashflow data at sector level (e.g., training data (e.g., 2 years, from January 2017 to December 2018) and/or testing data (e.g., 1 year, from January 2019 to December 2019)). In one embodiment, the set of agent profile datastructures may correspond to a set of funds that utilize the benchmark portfolio as their performance benchmark. In one implementation, the ML training request may be parsed (e.g., using PHP commands) to determine the set of agent profile datastructures (e.g., based on the value of the agent_profiles field). See FIG. 5, screen 501 for another example of a set of agent profile datastructures. In some implementations, fund trading data in the fund trading profiles may be pre-processed as follows:

At the starting time step, each fund’s total net asset value is
assigned to its corresponding benchmark value (i.e., Bₜ₌₀)
in order to align their size and use the actual benchmark return
at each time step to calculate their values afterwards (i.e.,
t > 0). These time series data in dollar amounts
(i.e., {xₜ, uₜ, Bₜ, Cₜ}ₜ₌₀^{T}) are then normalized
by dividing its initial value at t = 0.

An agent sample ranking function to utilize may be determined at 321. For example, an agent sample ranking function may be fund return, Sharpe ratio, Sortino ratio, and/or the like. In one embodiment, a fund trading profile of a fund specified via an agent profile datastructure may be utilized to rank the fund's performance during a certain training period (e.g., 2 years, from January 2017 to December 2018) by calculating the fund's return based on the difference between the end and starting total net assets excluding the cashflow amount (e.g., for fund return), and, for some agent sample ranking functions, by dividing the fund's return by the standard deviation of returns over the time period (e.g., for Sharpe ratio) or by dividing the fund's return by the standard deviation of negative returns over the time period (e.g., for Sortino ratio). In one implementation, the ML training request may be parsed (e.g., using PHP commands) to determine the agent sample ranking function to utilize (e.g., based on the value of the agent_sample_ranking_function field).

A range of agent samples to use may be determined at 325. In one embodiment, the range of agent samples to use may comprise some number of subsequences (e.g., 3 subsequences) of fund data of a certain length (e.g., from 5 to 10 months) from the set of agent profile datastructures. In various implementations, the number of subsequences, the length of each subsequence, the date range of each subsequence, and/or the like may be selected (e.g., predefined, randomly, within prespecified allowable ranges, and/or the like) to determine the range of agent samples to use. For example, the following subsequences may be used:

Subsequences
subsequence_0 ranges from 2017-01 to 2017-08
subsequence_1 ranges from 2017-06 to 2017-12
subsequence_2 ranges from 2017-08 to 2018-05

It is to be understood that, in various implementations, subsequences may be structured to have the same or different lengths, to be overlapping or disjoint, and/or the like.

A set of inverse reinforcement learning (IRL) training sample datastructures may be generated at 329. In one embodiment, an IRL training sample datastructure may comprise a pairwise comparison of rankings (e.g., as determined using the agent sample ranking function) of a pair of agents during a subsequence. For example, if agent_0 (e.g., with fund alias ID_fund_0) is ranked higher (e.g., based on fund return) during subsequence_0 than agent_1 (e.g., with fund alias ID_fund_1), then the following IRL training sample datastructure may be generated:

| X: | Y: |
|---|---|
| [agent_0_subsequence_0, agent_1_subsequence_0] | 0 |

in which X is a tuple comprising two agent-subsequence identifiers, and Y is binary value such that Y = 0 if the first element in tuple X is ranked higher, and Y = 1 if the second element in tuple X is ranked higher

In one implementation, each agent's rank during a subsequence may be compared with each of the other agents' ranks during the subsequence, for each of the subsequences, to determine the pairwise agent ranking order used to generate the set of IRL training sample datastructures. For example, the following set of IRL training sample datastructures may be generated for 3 agents and 3 subsequences:

| X: | Y: |
|---|---|
| [agent_0_subsequence_0, agent_1_subsequence_0] | 0 (e.g., agent_0 > agent_1) |
| [agent_0_subsequence_0, agent_2_subsequence_0] | 0 (e.g., agent_0 > agent_2) |
| [agent_1_subsequence_0, agent_2_subsequence_0] | 1 (e.g., agent_1 < agent_2) |
| [agent_0_subsequence_1, agent_1_subsequence_1] | 0 |
| [agent_0_subsequence_1, agent_2_subsequence_1] | 0 |
| [agent_1_subsequence_1, agent_2_subsequence_1] | 1 |
| [agent_0_subsequence_2, agent_1_subsequence_2] | 0 |
| [agent_0_subsequence_2, agent_2_subsequence_2] | 0 |
| [agent_1_subsequence_2, agent_2_subsequence_2] | 1 |

In some alternative implementations, instead of using ranks during subsequences, ranks during the entire training period (e.g., 2 years) may be used to make pairwise comparisons of rankings (e.g., agent_0>agent_2>agent_1 for each subsequence).

A reward function structure to use for inverse reinforcement learning may be determined at 333. In one embodiment, a parametric reward function may be used. In one implementation, a parametric T-REX function may be used. For example, the reward function structure to use for IRL may be specified as follows:

Let O : {S, A} be a state-action space of a Markov decision process (MDP) environment,
and \hat{r}₀(·) with parameters 0 be a target reward function to be optimized in the IRL problem.
Let the state vector xₜ ∈ R^{N} be a vector of dollar values of stock positions in each
sector at time t.
Let the action variable uₜ ∈ R^{N} be given by the vector of changes in these positions as
a result of trading at time step t.
Let the state vector rₜ ∈ R^{N} represent the asset returns as a random variable with the
mean r̅ₜ and covariance matrix Σᵣ.
Let the state transition model be defined as follows:
xₜ₊₁ = Aₜ(xₜ + uₜ), Aₜ = diag(1 + rₜ)
The reward function Rₜ is structured as follows:
Rₜ(xₜ, uₜ|0) = − [symbol] ) [(\hat{P}ₜ − Vₜ)²] − λ · (1^{T}uₜ − Cₜ)² − ω · uₜ^{T}uₜ
where Cₜ is a money flow to the fund, λ and ω are parameters, and
\hat{P}ₜ = ρ · Bₜ + (1 − ρ) · η · 1^{T}xₜ
Vₜ = (1 + rₜ)^{T}(xₜ + uₜ)
where η and ρ are additional parameters, and Bₜ is a benchmark portfolio
The reward functions has three terms. In the first term, \hat{P}ₜ defines the target
portfolio market value at time t. It is specified as a linear combination of a
reference benchmark portfolio value Bₜ and the current portfolio’s self-growing value
with rate η, where ρ ∈ [0, 1] is a parameter defining the relative weight between the two
terms. Vₜ gives the portfolio value at time t + Δt, after the trade uₜ is made at time t.
The first term imposes a penalty for under-performance of the traded portfolio relative
to its moving target. The second term enforces the constraint that the total amount of
trades in the portfolio should match the inflow Cₜ to the portfolio at each time step,
with λ being a parameter penalizing violations of the equality constraint. The third
term approximates transaction costs by a quadratic function with parameter ω, thus
serving as a L₂ regularization, The vector 0 of model parameters thus contains four
reward parameters {ρ, η, λ, ω}.

An IRL technique may be used on the set of IRL training sample datastructures to determine an optimal reward function at 337. For example, the T-REX IRL technique may be used (e.g., specified via the ML training request (e.g., based on the value of the IRL_technique_identifier field)). In one embodiment, the IRL technique may be used to infer the intent of asset managers from observing their trading decisions (e.g., rather than to imitate investment policies of asset managers) to improve over their investment decisions. In one implementation, the T-REX technique may be used to solve a binary classification problem to learn parameters (e.g., the four parameters {ρ, η, λ, w}) of the optimal reward function that keep the pairwise agent ranking order that is based on the agent sample ranking function. For example, the T-REX technique may be used as follows:

Let 0 : {S, A} be a state-action space of an MDP environment, and \hat{r}_{θ}(·)
with parameters θ be a target reward function to be optimized in the IRL
problem. Given M ranked observed subsequences {oₘ}ₘ₌₁^{M} (oᵢ [symbol] oⱼ if
i < j, where ″ [symbol] ″ indicates the pairwise agent ranking order between
pairwise subsequences), the T-REX technique may be used to conduct
reward inference by solving the following optimization problem:
${max}_{θ} {\sum }_{{o}_{i} ≺ {o}_{j}} log \frac{{e}^{{\sum }_{\{ s , a \} {ϵo}_{j}} {\hat{r}}_{θ} ( s , a )}}{{e}^{{\sum }_{\{ s , a \} {ϵo}_{i}} {\hat{r}}_{θ} ( s , a )} + {e}^{{\sum }_{\{ s , a \} {ϵo}_{j}} {\hat{r}}_{θ} ( s , a )}}$
This objective function is equivalent to the softmax normalized cross-
entropy loss in a binary classifier, and may be trained using machine
learning libraries such as PyTorch or TensorFlow. As a result, the
learned optimal reward function can preserve theranking orders
between pairs of subsequences.

A prior policy π⁽⁰⁾ may be determined at 341. In one embodiment, the prior policy π⁽⁰⁾ may encode domain knowledge of real world problems. In one implementation, the prior policy π⁽⁰⁾ is fitted to a multivariate Gaussian distribution with a constant mean and variance calculated from sector trades in the training set (e.g., pre-processed fund trading data).

Hyperparameters for a reinforcement learning technique (e.g., G-Learner) may be determined at 345. For example, default values of hyperparameters may be used (e.g., previously tuned values). In another example, values of hyperparameters may be specified via the ML training request. In one embodiment, hyperparameters may be used to control the training In one implementation, the hyperparameters may include a discount factor γ for the future value of rewards. In another implementation, the hyperparameters may include a KL, regularizer magnitude β. G-learner controls the deviation of the optimal policy πₜ from the prior policy π⁽⁰⁾ by incorporating the KL, divergence of πₜ and π⁽⁰⁾ into the optimal reward function (e.g., a modified, regularized reward function) with a hyperparameter β that controls the magnitude of the KL, regularizer. When β is large, the deviation can be arbitrarily large, while in the limit β→0, πₜ is forced to be equal to π⁽⁰⁾, so there is no learning in this limit

A set of reinforcement learning (RL) training sample datastructures may be generated at 349. In one embodiment, an RL training sample datastructure may comprise training data (e.g., pre-processed fund trading data) for an agent (e.g., a fund) for the duration of the training period (e.g., 2 years, from January 2017 to December 2018) as a time series. In one implementation, the agents' agent profile datastructures may be processed (e.g., parsed) to generate the set of RL training sample datastructures. In some implementations, the set of RL training sample datastructures may be used to estimate the sector return covariance matrix Σᵣ.

A determination may be made at 353 whether an optimal policy was learned. In one implementation, the optimal policy is learned when parameters of the optimal policy converge (e.g., based on a predefined difference threshold).

If the optimal policy was not learned yet, an RL technique may be used on the set of RL training samples to learn the optimal policy at 357. For example, the G-Learner RL technique may be used (e.g., specified via the ML training request (e.g., based on the value of the RL_technique_identifier field)). In one implementation, the G-Learner technique may be used to learn parameters (e.g., the three parameters ũₜ, \tilde{v}ₜ, \tilde{Σ}ₚ) of the optimal policy. For example, the G-Learner technique may be used as follows:

```
Let Fₜ be the value function of xₜ.
Let Gₜ be the action-value function of xₜ and uₜ pairs.
To obtain the optimal policy model parameters at the terminal state
(i.e., F_{T}* and G_{T}*)
${let \frac{\partial {R}_{t} ( {x}_{t} , {u}_{t} )}{\partial {u}_{t}} \vert}_{t = T} = 0. Thereafter , the policy model parameters$
associated with earlier time steps can be derived in a backpropagated
way starting from the end step as shown in the for-loop of the function
below:
G-Learner Optimization Function
Input: λ, ω, η, ρ, β ,γ, {r̅ₜ, xₜ, uₜ, Bₜ, Cₜ}ₜ₌₀^{T}, Σᵣ, π⁽⁰⁾
Output: π_{T}^{*} = π⁽⁰⁾ · e^{β(G}^{_{T}}^{^{*}}^{-F}^{_{T}}^{^{*}}⁾, t = 0, . . . , T
Initialize: F_{T}^{*}, G_{T}^{*}
while not converge do
  for t ∈ [T − 1, −1, 0] do
    Fₜ ← Value_Update(Fₜ₋₁, Gₜ₋₁)
    Gₜ ← ValueAction_Update(Fₜ, Gₜ₋₁)
  end
end
return {F_{T}^{*}, G_{T}^{*}}_{t = 0}^{T}
```

If the optimal policy was learned, an optimal policy datastructure may be stored at 361. In one implementation, the optimal policy datastructure may comprise the parameters (e.g., the three parameters ũₜ, \tilde{v}ₜ, \tilde{Σ}ₚ) of the optimal policy and may define the prediction logic. In one embodiment, the three parameters ũₜ, \tilde{v}ₜ, \tilde{Σ}ₚ are time dependent and define the Gaussian distribution of the learned policy πₜ for each time step. For example, the optimal policy datastructure (e.g., prediction logic structure that defines the prediction logic) may be stored in the ML table 1419j.

FIG. 4 shows non-limiting, example embodiments of a logic flow illustrating an optimized order executing (OOE) component for the MRLAPM. In FIG. 4, an order optimization datastructure may be obtained at 401. For example, the order optimization datastructure may be obtained as a result of a user sending an order optimization input to facilitate placing an order with optimal order parameters. See FIG. 5, screen 505 for another example of an order optimization datastructure that may be provided.

An order constraint value may be determined at 405. For example, the order constraint value may be a cashflow value associated with a fund (e.g., deposits and/or withdrawals for the fund). In one embodiment, the order constraint value puts a constraint on the total recommended trades (e.g., SUM(recommended_trades)=cashflow). See FIG. 5, screen 510 for an example of recommended trades and an associated cashflow value. In one implementation, the order optimization datastructure may be parsed (e.g., using PHP commands) to determine the order constraint value (e.g., based on the value of the cashflow field).

A set of buckets to use may be determined at 409. For example, buckets may correspond to the 11 sectors of the S&P 500 index. In one implementation, the order optimization datastructure may be parsed (e.g., using PHP commands) to determine the set of buckets to use (e.g., based on the value of the buckets field).

A determination may be made at 413 whether there remain buckets to process. In one implementation, each of the buckets in the set of buckets to use may be processed. If there remain buckets to process, the next bucket may be selected for processing at 417.

Holdings for the selected bucket may be determined at 421. For example, holdings for a bucket may specify the current value (e.g., in dollars) of security positions (e.g., stocks) in the bucket for the fund. In one implementation, the order optimization datastructure may be parsed (e.g., using PHP commands) to determine the holdings for the selected bucket (e.g., based on the value of the holdings field).

An optimal policy datastructure may be retrieved at 425. In one embodiment, the optimal policy datastructure may comprise data fields that specify the structure of a prediction logic that corresponds to an optimal policy π that provides trading recommendations. In one implementation, the order optimization datastructure may be parsed (e.g., using PHP commands) to determine the optimal policy datastructure specified by the user (e.g., based on the value of the prediction_logic_identifier field) and/or the specified optimal policy datastructure may be retrieved from a repository. In another implementation, a default optimal policy datastructure (e.g., for the fund) may be retrieved from a repository.

Optimal order parameters may be computed using the optimal policy datastructure at 429. In one embodiment, the optimal order parameters may specify a set of recommended trades to place based on the current holdings and the order constraint value. In one implementation, the current sector holdings and the cashflow value for the fund may be provided as input to the retrieved prediction logic, and the retrieved prediction logic may provide a set of recommended trades as output. For example, the recommended action at time t may be given by the mode of the action policy for the given state xₜ (e.g., generate K samples (e.g., the best value of K may be tuned based on empirical studies and/or the system computation capacity) of uₜ by simulating using the optimal policy datastructure, and choose the uₜ with the highest reward). See FIG. 5, screen 510 for an example of recommended trades. In some implementations, computation of the optimal order parameters may also involve checking the feasibility of recommended allocations, controlling for potential market impact effects and/or transaction costs (e.g., by selecting a venue (e.g., stock exchange, dark pool) with the least market impact and/or the lowest transaction costs), and/or the like.

One or more order placement request datastructures may be sent to one or more exchange servers at 433. In one implementation, the one or more order placement requests may be sent in accordance with the computed optimal order parameters.

FIG. 5 shows non-limiting, example embodiments of implementation case(s) for the MRLAPM. Screen 501 illustrates a datastructure that may be provided as input to train a prediction logic, which specifies monthly fund holdings, trade, and cashflow data (e.g., in dollar amounts at month end from January 2017 to December 2019) at sector level for a set of funds that are benchmarked by S&P 500.

Screen 505 illustrates a datastructure that may be provided as input to the trained prediction logic, which specifies a cashflow value and current sector holdings for a fund. Screen 510 illustrates a datastructure that may be provided as output from the trained prediction logic, which specifies recommended trades for the fund.

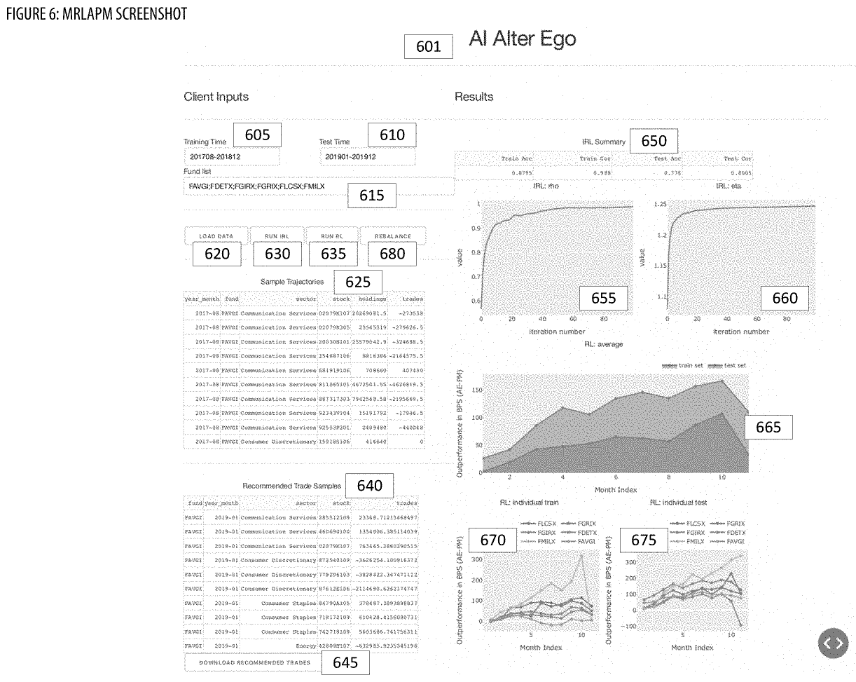

FIG. 6 shows non-limiting, example embodiments of a screenshot illustrating user interface(s) of the MRLAPM. In FIG. 6, an exemplary user interface (e.g., for a mobile device, for a website) for training a prediction logic and/or placing an order with optimal order parameters is illustrated. Screen 601 shows that a user may specify a training period via a “Training Time” widget 605, a testing period via a “Test Time” widget 610, and a set of funds to be studied via a “Fund list” widget 615. The user may use the “LOAD DATA” button 620 to load the training and/or test data into memory, and samples of data will show up in the “Sample Trajectories” table 625. The user may use the “RUN IRL” button 630 to use the IRL technique and the “RUN RL” button 635 to use the RL technique to learn an optimal policy. The user may view recommended trades in the “Recommended Trade Samples” table 640. The user may use the “Download Recommended Trades” button 645 to download the recommended trades (e.g., as a CSV file). Upon finishing the IRL execution, the table “IRL Summary” 650 lists the success metrics of the learning process against the training data, and charts “IRL: rho” 655 and “IRL: eta” 660 illustrate the converge curve for reward parameters rho and eta. The RL module provides the recommended trades for the test period and also plots figures “RL: average” 665, “RL: individual train” 670, and “RL: individual test” 675 to show the outperformance of MRLAPM-driven portfolio over fund managers' history in the back test. The user may use the “REBALANCE” button 680 to place an order corresponding to the recommended trades.

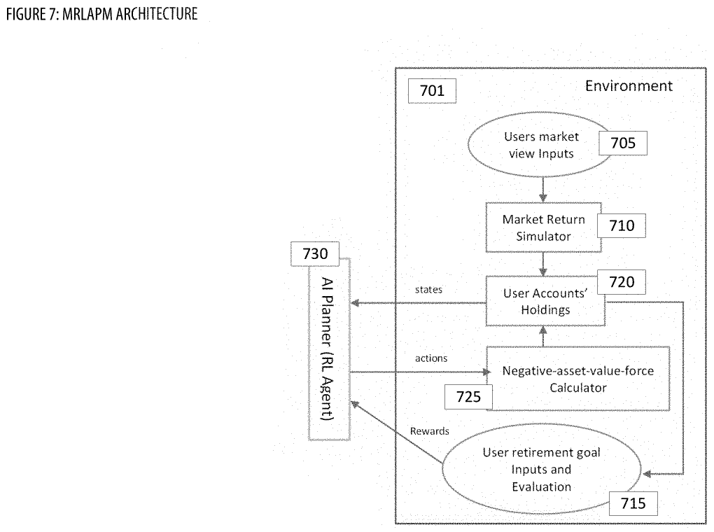

FIG. 7 shows non-limiting, example embodiments of an architecture for the MRLAPM. In FIG. 7, an embodiment of how an AI Planner (RL Agent) 730 may interact with a user retirement planning environment 701 to learn an optimized withdrawal policy is illustrated.

The RL agent datastructure (e.g., model) takes states information (e.g., user account values, age, year of retirement) from the environment as inputs and outputs account withdrawals (e.g., from brokerage, IRA, Roth, TDA, and/or the like accounts) as actions. The RL agent also receives rewards as feedback from the environment after its actions are applied to the environment. The reward functions are designed to mainly evaluate the level of satisfaction of user specified goals (e.g., bequest, total after-negative-asset-value-force (e.g., after fees, losses, taxes, and/or the like negative-asset-value-forces) periodic (e.g., annual) withdrawal amount (ATWD), life event fulfillments).

The RL agent datastructure is trained using states and rewards collected from its interaction with the environment. Once training is completed, the RL agent datastructure is able to provide optimal account withdrawals that can meet users' retirement goals starting from his/her retirement age and throughout the planning period.

The environment may comprise a set of components 705-725. A user market view inputs component 705 may comprise users' market view in terms of expected equity, bond and cash returns as inputs. Given user account's portfolio allocation, the expected portfolio return can be calculated accordingly. In various implementations, the expected portfolio returns may be: (1) constant values, (2) samples from a probabilistic distribution (e.g., Gaussian distribution with user specified mean and standard deviation), (3) samples from portfolio return paths with user specified mean and standard deviation, and/or the like. If (2) or (3) is selected, a market return simulator component 710 may be utilized to conduct return simulation from a probabilistic distribution or evenly from return paths in a given planning year. The simulated portfolio returns of a current year may be utilized to calculate the next year's account holdings.

A user retirement goal inputs and evaluation component 715 may obtain goals/user retirement requests inputs such as: a list of life events' expenses in dollar amount at corresponding years, expected bequest in dollar amount at the end of the planning period, a range of after-negative-asset-value-force periodic (e.g., annual) withdrawals (ATWDs) in dollar amount, expected retirement year and planning length, and/or the like. The user retirement goal inputs and evaluation component may evaluate the satisfaction of the goals/user retirement requests, and provide feedbacks as rewards to the RL agent.

A user accounts' holdings component 720 may store information regarding user accounts such as brokerage, IRA, Roth, TDA, and/or the like accounts to facilitate optimizing the account withdrawal location problem to satisfy user retirement planning requests. In some implementations, information regarding a user's SSN income and year, spouse's accounts and SSN income, and/or the like may be stored and utilized. A user's account values for the next year may be calculated based on a current year's values, annual withdrawals, and portfolio returns.

A negative-asset-value-force calculator component 725 may calculate negative-asset-value-force cost from users' account withdrawals. In some embodiments, filing information such as state of taxation, filing status (e.g., single, married filing jointly, married filing separately), withholding rate, required minimum distribution (RMD) from IRA, and/or the like may be utilized. In one implementation, the negative-asset-value-force calculator component may execute through online API calls running through a full process of negative-asset-value-force calculation with more accurate negative-asset-value-force cost estimation but longer execution time. In another implementation, the negative-asset-value-force calculator component may execute through a machine learning estimator: negative-asset-value-force estimation via a pre-trained (e.g., XGBoost) estimator, which takes account withdrawals and filing information as inputs. The estimator is trained by the data collected from inputs and outputs from API calls, and provides a faster estimation.

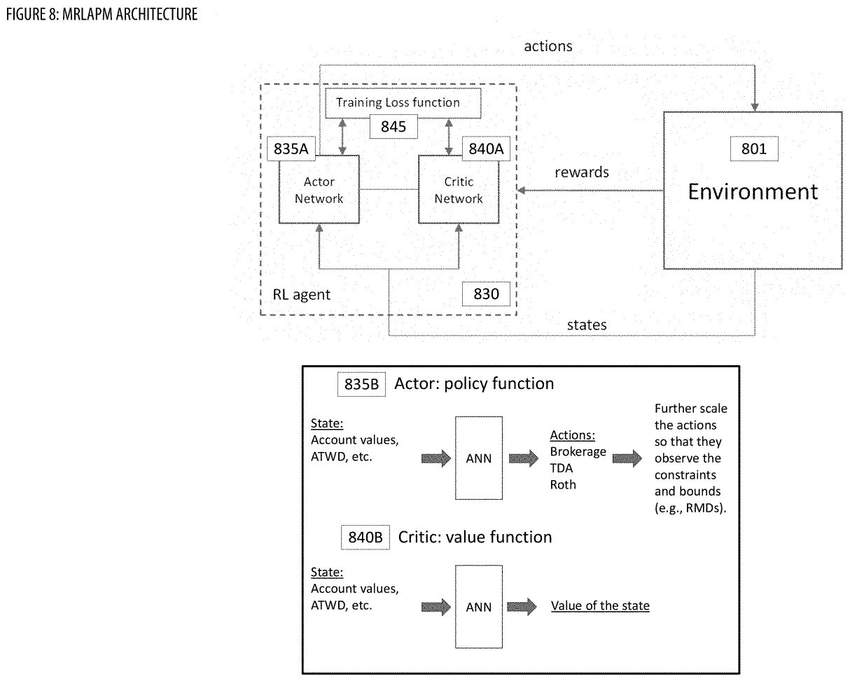

FIG. 8 shows non-limiting, example embodiments of an architecture for the MRLAPM. In FIG. 8, an embodiment of how an RL Agent 830 may interact with a user retirement planning environment 801 to learn an optimized withdrawal policy is illustrated.

In one implementation, the RL Agent comprises an actor artificial neural network (ANN) 835A and a critic artificial neural network 840A. As shown at 835B, the actor ANN may take state as input and output optimal account withdrawal actions, which may be further scaled to observe various constraints and/or bounds (e.g., RMDs). As shown at 840B, the critic ANN may take state as input and output the value of the state (e.g., reward predicted by the critic ANN based on the state).

In the training phase, the RL agent datastructure (e.g., model) may switch between two execution modes:

Exploration Mode: In this mode, the RL agent keeps interacting with the environment by taking states as inputs, providing actions via the current actor network, and receiving rewards (e.g., as specified by a reward function (e.g., total reward=intermediate years rewards+final year reward, where annual rewards are specified by a sigmoid function with a penalty)). Explored records including {state, action, reward} are collected.

ANN Update Mode: Once enough records are collected, the RL agent datastructure is switched to update the actor and critic network parameters through an RL technique (e.g., Proximal Policy Optimization (PPO) method) using the collected data and a training loss function 845 (e.g., Training_loss_function=Critic_loss+Actor_loss+Entropy_loss, where Critic_loss is the Mean Squared Error (MSE) between rewards and critic values, and critic values are the outputs from critic network given states as inputs, where Actor_loss=−1*(New policy probability/old policy probability)*(rewards—state value), and where Entropy_loss is added to encourage exploration).

Once the ANN parameters are updated, the RL agent datastructure is switched back to the exploration mode to collect more data. Such iterations stop when the average rewards from consecutive iterations don't change (e.g., beyond a specified threshold), which can be a sign of the training phase's convergence. Once the training phase converges, the actor network may be saved and deployed to provide optimal account withdrawals in dollar amount based upon users' requests.

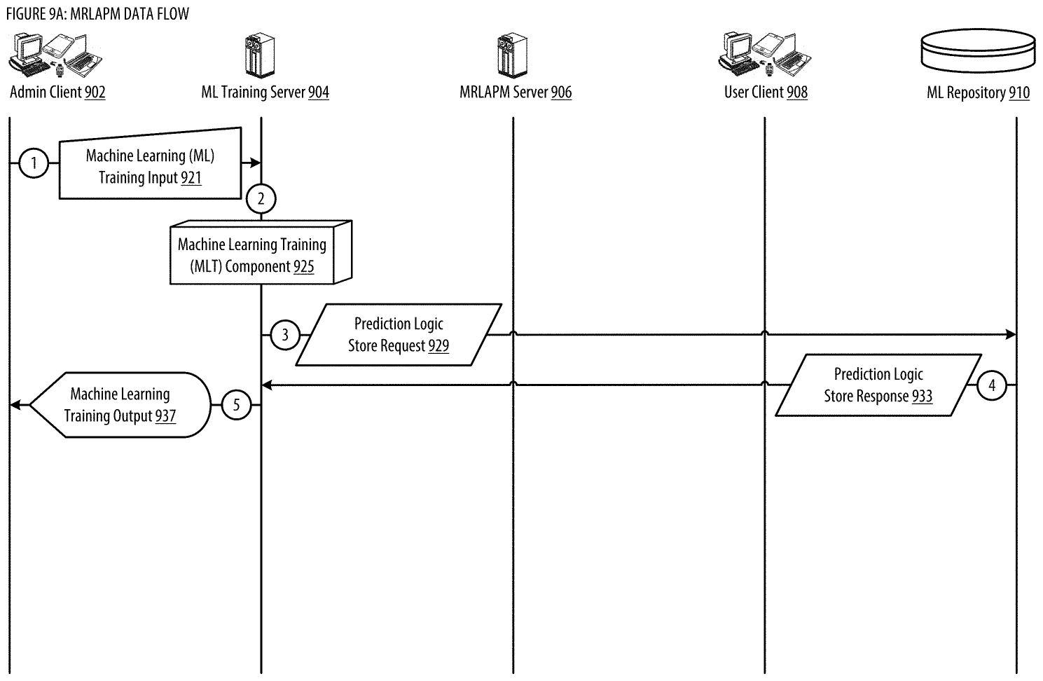

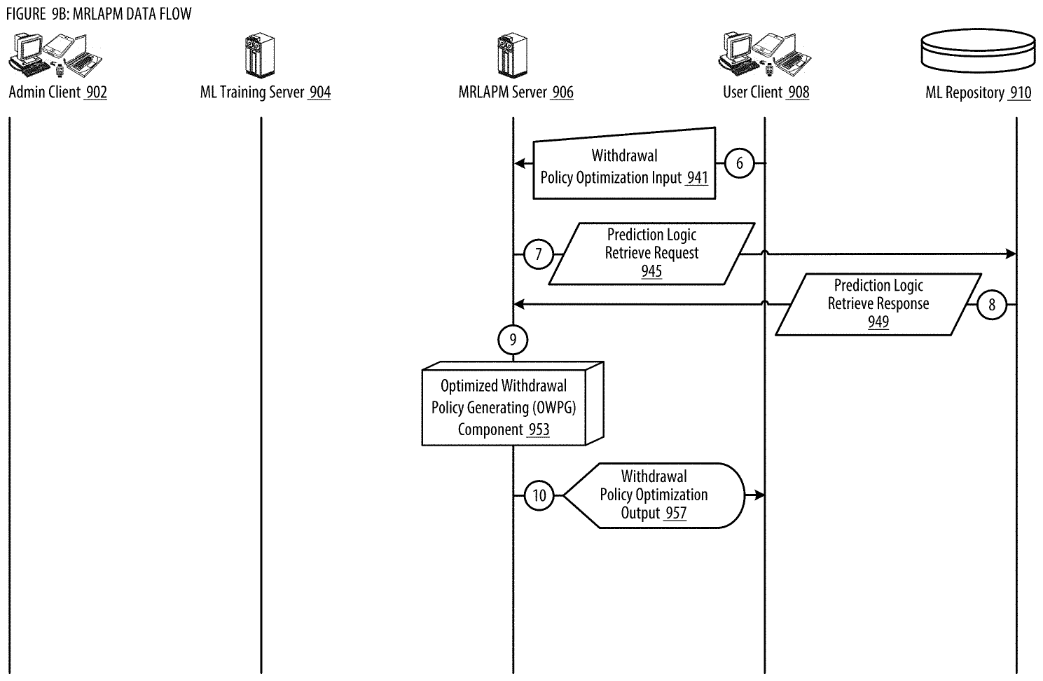

FIGS. 9A-B show non-limiting, example embodiments of a datagraph illustrating data flow(s) for the MRLAPM. In FIGS. 9A-B, an admin client 902 (e.g., of an administrative user) may send a machine learning (ML) training input 921 to a ML training server 904 to facilitate training a prediction logic using a machine learning technique. For example, the admin client may be a desktop, a laptop, a tablet, a smartphone, a smartwatch, and/or the like that is executing a client application. In one implementation, the ML training input may include data such as a request identifier, RL technique details, configuration parameters for the RL technique, a set of training sample configuration datas truc tures, market return simulator settings, and/or the like. In one embodiment, the admin client may provide the following example ML training input, substantially in the form of a (Secure) Hypertext Transfer Protocol (“HTTP(S)”) POST message including eXtensible Markup Language (“XML”) formatted data, as provided below:

```
POST /authrequest.php HTTP/1.1
Host: www.server.com
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
    <user_account_credentials>
      <user_name>JohnDaDoeDoeDoooe@gmail.com</user_name>
      <password>abc123</password>
      //OPTIONAL <cookie>cookieID</cookie>
      //OPTIONAL <digital_cert_link>www.mydigitalcertificate.com/
JohnDoeDaDoeDoe@gmail.com/mycertifcate.dc</digital_cert_link>
      //OPTIONAL <digital_certificate>_DATA_</digital_certificate>
    </user_account_credentials>
  </user_accounts_details>
  <client_details> //iOS Client with App and Webkit
      //it should be noted that although several client details
      //sections are provided to show example variants of client
      //sources, further messages will include only on to save
      //space
    <client_IP>10.0.0.123</client_IP>
    <user_agent_string>Mozilla/5.0 (iPhone; CPU iPhone OS 7_1_1 like Mac OS X)
AppleWebKit/537.51.2 (KHTML, like Gecko) Version/7.0 Mobile/11D201
Safari/9537.53</user_agent_string>
    <client_product_type>iPhone6,1</client_product_type>
    <client_serial_number>DNXXX1X1XXXX</client_serial_number>
    <client_UDID>3XXXXXXXXXXXXXXXXXXXXXXXXD</client_UDID>
    <client_OS>iOS</client_OS>
    <client_OS_version>7.1.1</client_OS_version>
    <client_app_type>app with webkit</client_app_type>
    <app_installed_flag>true</app_installed_flag>
    <app_name>MRLAPM.app</app_name>
    <app_version>1.0 </app_version>
    <app_webkit_name>Mobile Safari</client_webkit_name>
    <client_version>537.51.2</client_version>
  </client_details>
  <client_details> //iOS Client with Webbrowser
    <client_IP>10.0.0.123</client_IP>
    <user_agent_string>Mozilla/5.0 (iPhone; CPU iPhone OS 7_1_1 like Mac OS X)
AppleWebKit/537.51.2 (KHTML, like Gecko) Version/7.0 Mobile/11D201
Safari/9537.53</user_agent_string>
    <client_product_type>iPhone6,1</client_product_type>
    <client_serial_number>DNXXX1X1XXXX</client_serial_number>
    <client_UDID>3XXXXXXXXXXXXXXXXXXXXXXXXD</client_UDID>
    <client_OS>iOS</client_OS>
    <client_OS_version>7.1.1</client_OS_version>
    <client_app_type>web browser</client_app_type>
    <client_name>Mobile Safari</client_name>
    <client_version>9537.53</client_version>
  </client_details>
  <client_details> //Android Client with Webbrowser
    <client_IP>10.0.0.123</client_IP>
    <user_agent_string>Mozilla/5.0 (Linux; U; Android 4.0.4; en-us; Nexus S
Build/IMM76D) AppleWebKit/534.30 (KHTML, like Gecko) Version/4.0 Mobile
Safari/534.30</user_agent_string>
    <client_product_type>Nexus S</client_product_type>
    <client_serial_number>YXXXXXXXXZ</client_serial_number>
    <client_UDID>FXXXXXXXXX-XXXX-XXXX-XXXX-XXXXXXXXXXXXX</client_UDID>
    <client_OS>Android</client_OS>
    <client_OS_version>4.0.4</client_OS_version>
    <client_app_type>web browser</client_app_type>
    <client_name>Mobile Safari</client_name>
    <client_version>534.30</client_version>
  </client_details>
  <client_details> //Mac Desktop with Webbrowser
    <client_IP>10.0.0.123</client_IP>
    <user_agent_string>Mozilla/5.0 (Macintosh; Intel Mac OS X 10_9_3)
AppleWebKit/537.75.14 (KHTML, like Gecko) Version/7.0.3
Safari/537.75.14</user_agent_string>
    <client_product_type>MacPro5,1</client_product_type>
    <client_serial_number>YXXXXXXXXZ</client_serial_number>
    <client_UDID>FXXXXXXXXX-XXXX-XXXX-XXXX-XXXXXXXXXXXXX</client_UDID>
    <client_OS>Mac OS X</client_OS>
    <client_OS_version>10.9.3</client_OS_version>
    <client_app_type>web browser</client_app_type>
    <client_name>Mobile Safari</client_name>
    <client_version>537.75.14</client_version>
  </client_details>
  <machine_learning_training_input>
    <request_identifier>ID_request_11</request_identifier>
    <RL_technique_identifier>ID_PPO</RL_technique_identifier>
    <configuration_parameters>
      <number_of_networks>10</number_of_networks>
      <optimal_policy_reward_function>
        total = intermediate years + final year
        intermediate years: 1 if the ATWD is met, penalty otherwise
        final year: sum of market values of the accounts
      </optimal_policy_reward_function>
    </configuration_parameters>
    <training_sample_configurations>
      <training_sample_configuration>
        <training_sample_configuration_identifier>
          ID_training_sample_configuration_1
        </training_sample_configuration_identifier>
    <accounts>
      <account>
        <account_identifier>ID_account_1</account_identifier>
        <account_type>BROKERAGE</account_type>
        <account_amount>$215,000</account_amount>
      </account>
      <account>
        <account_identifier>ID_account_2</account_identifier>
        <account_type>TDA</account_type>
        <account_amount>$310,000</account_amount>
      </account>
      <account>
        <account_identifier>ID_account_3</account_identifier>
        <account_type>ROTH</account_type>
        <account_amount>$235,000</account_amount>
      </account>
    </accounts>
    <incomes>
      <income>
        <income_identifier>ID_income_1</income_identifier>
        <income_type>SOCIAL_SECURITY</income_type>
        <income_amount>$10,000</income_amount>
        <income_date_start>01/01/2026</income_date_start>
        <income_date_end>PERPETUAL</income_date_end>
      </income>
      <income>
        <income_identifier>ID_income_2</income_identifier>
        <income_type>JOB</income_type>
        <income_amount>$20,000</income_amount>
        <income_date_start>01/01/2026</income_date_start>
        <income_date_end>01/01/2031</income_date_end>
      </income>
    </incomes>
    <retirement_start_year>2026</retirement_start_year>
    <retirement_start_age>67</retirement_start_age>
    <ATWD_constant>$80,000</ATWD_constant>
    <ATWD_variable>
      <retirement_year>10</retirement_year>
      <amount>+$200,000</amount>
    </ATWD_variable>
    <bequest>
      <retirement_year>40</retirement_year>
      <amount>$100,000</amount>
    </bequest>
  </training_sample_configuration>
  <training_sample_configuration>
      <training_sample_configuration_identifier>
          ID_training_sample_configuration_2
      </training_sample_configuration_identifier>
      <accounts>
        <account>
          <account_identifier>ID_account_11</account_identifier>
          <account_type>BROKERAGE</account_type>
          <account_amount>$325,000</account_amount>
        </account>
        <account>
          <account_identifier>ID_account_12</account_identifier>
          <account_type>TDA</account_type>
          <account_amount>$100,000</account_amount>
        </account>
        <account>
          <account_identifier>ID_account_13</account_identifier>
          <account_type>ROTH</account_type>
          <account_amount>$225,000</account_amount>
        </account>
      </accounts>
      <incomes>
        <income>
          <income_identifier>ID_income_11</income_identifier>
          <income_type>SOCIAL_SECURITY</income_type>
          <income_amount>$30,000</income_amount>
          <income_date_start>01/01/2026</income_date_start>
          <income_date_end>PERPETUAL</income_date_end>
        </income>
      </incomes>
      <retirement_start_year>2026</retirement_start_year>
      <retirement_start_age>66</retirement_start_age>
      <ATWD_constant>$60,000</ATWD_constant>
      <ATWD_variable>
        <retirement_year>1</retirement_year>
        <amount>−$20,000</amount>
      </ATWD_variable>
      <ATWD_variable>
        <retirement_year>2</retirement_year>
        <amount>−$20,000</amount>
      </ATWD_variable>
    </training_sample_configuration>
    ...
  </training_sample_configurations>
  <market_return_simulator_settings>
    PREDEFINED_MARKET_PATHS
  </market_return_simulator_settings>
  </machine_learning_training_input>
</auth_request>
```

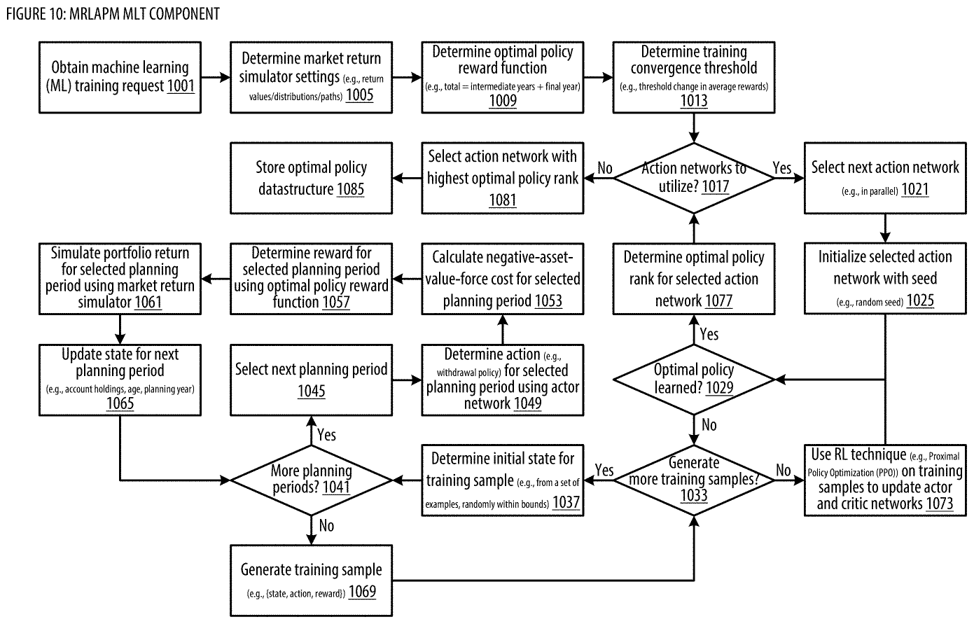

A machine learning training (MLT) component 925 may utilize data provided in the ML training input to train a prediction logic that provides optimized withdrawal policy recommendations. See FIG. 10 for additional details regarding the MLT component.

The ML training server 904 may send a prediction logic store request 929 to a ML repository 910 to store the trained prediction logic. In one implementation, the prediction logic store request may include data such as a request identifier, a request type, a prediction logic identifier, prediction logic trained structure, and/or the like. In one embodiment, the ML training server may provide the following example prediction logic store request, substantially in the form of a HTTP(S) POST message including XML-formatted data, as provided below:

```
POST /prediction_logic_store_request.php HTTP/1.1
Host: www.server.com
Content-Type: Application/XML
Content-Length: 667
<?XML version = “1.0” encoding = “UTF-8”?>
<prediction_logic_store_request>
  <request_identifier>ID_request_12</request_identifier>
  <request_type>STORE</request_type>
  <prediction_logic_identifier>ID_prediction_logic_11</prediction_logic_identifier>
  <prediction_logic_trained_structure>
  optimaL poLicy datastructure
  </prediction_logic_trained_structure>
</prediction_logic_store_request>
```

The ML repository 910 may send a prediction logic store response 933 to the ML training server 904 to confirm that the trained prediction logic was stored successfully. In one implementation, the prediction logic store response may include data such as a response identifier, a status, and/or the like. In one embodiment, the ML repository may provide the following example prediction logic store response, substantially in the form of a HTTP(S) POST message including XML-formatted data, as provided below:

```
POST /prediction_logic_store_response.php HTTP/1.1
Host: www.server.com
Content-Type: Application/XML
Content-Length: 667
<?XML version = “1.0” encoding = “UTF-8”?>
<prediction_logic_store_response>
  <response_identifier>ID_response_12</response_identifier>
  <status>OK</status>
</prediction_logic_store_response>
```

The ML training server 904 may send a machine learning training output 937 to the admin client 902 to inform the administrative user that training was completed successfully. In one implementation, the machine learning training output may include data such as a response identifier, a status, and/or the like. In one embodiment, the ML training server may provide the following example machine learning training output, substantially in the form of a HTTP(S) POST message including XML-formatted data, as provided below:

```
POST /machine_learning_training_output.php HTTP/1.1
Host: www.server.com
Content-Type: Application/XML
Content-Length: 667
<?XML version = “1.0” encoding = “UTF-8”?>
<machine_learning_training_output>
  <response_identifier>ID_response_11</response_identifier>
  <status>OK</status>
</machine_learning_training_output>
```

A user client 908 (e.g., of a user) may send a withdrawal policy optimization input 941 to a MRLAPM server 906 to facilitate obtaining an optimized withdrawal policy datastructure. For example, the user client may be a desktop, a laptop, a tablet, a smartphone, a smartwatch, and/or the like that is executing a client application. In one implementation, the withdrawal policy optimization input may include data such as a request identifier, a prediction logic identifier, an initial state, market return simulator settings, and/or the like. In one embodiment, the user client may provide the following example withdrawal policy optimization input, substantially in the form of a HTTP(S) POST message including XML-formatted data, as provided below:

```
POST /withdrawal_policy_optimization_input.php HTTP/1.1
Host: www.server.com
Content-Type: Application/XML
Content-Length: 667
<?XML version = “1.0” encoding = “UTF-8”?>
<withdrawal_policy_optimization_input>
    <request_identifier>ID_request_13</request_identifier>
    <prediction_logic_identifier>ID_prediction_logic_11</prediction_logic_identifier>
    <initial_state>
        <user_identifier>ID_user_11</user_identifier>
        <accounts>
            <account>
                  <account_identifier>ID_account_1</account_identifier>
                  <account_type>BROKERAGE</account_type>
                  <account_amount>$225,000</account_amount>
              </account>
              <account>
                  <account_identifier>ID_account_2</account_identifier>
                  <account_type>TDA</account_type>
                  <account_amount>$300,000</account_amount>
              </account>
              <account>
                  <account_identifier>ID_account_3</account_identifier>
                  <account_type>ROTH</account_type>
                  <account_amount>$225,000</account_amount>
              </account>
          </accounts>
          <incomes>
              <income>
                  <income_identifier>ID_income_1</income_identifier>
                  <income_type>SOCIAL_SECURITY</income_type>
                  <income_amount>$10,000</income_amount>
                  <income_date_start>01/01/2026</income_date_start>
                  <income_date_end>PERPETUAL</income_date_end>
              </income>
          </incomes>
          <retirement_start_year>2026</retirement_start_year>
          <retirement_start_age>67</retirement_start_age>
          <ATWD_constant>$80,000</ATWD_constant>
          <ATWD_variable>
              <retirement_year>5</retirement_year>
              <amount>+$200,000</amount>
          </ATWD_variable>
          <bequest>
              <retirement_year>40</retirement_year>
              <amount>$300,000</amount>
          </bequest>
      </initial_state>
      <market_return_simulator_settings>
          <equity>20%</equity>
          <conditions>POOR_MARKET</conditions>
      </market_return_simulator_settings>
  </withdrawal_policy_optimization_input>
```

The MRLAPM server 906 may send a prediction logic retrieve request 945 to the ML repository 910 to retrieve a trained prediction logic. In one implementation, the prediction logic retrieve request may include data such as a request identifier, a request type, a prediction logic identifier, and/or the like. In one embodiment, the MRLAPM server may provide the following example prediction logic retrieve request, substantially in the form of a HTTP(S) POST message including XML-formatted data, as provided below:

```
POST /prediction_logic_retrieve_request.php HTTP/1.1
Host: www.server.com
Content-Type: Application/XML
Content-Length: 667
<?XML version = “1.0” encoding = “UTF-8”?>
<prediction_logic_retrieve_request>
    <request_identifier>ID_request_14</request_identifier>
    <request_type>RETRIEVE</request_type>
    <prediction_logic_identifier>ID_prediction_logic_11</prediction_logic_identifier>
</prediction_logic_retrieve_request>
```

The ML repository 910 may send a prediction logic retrieve response 949 to the MRLAPM server 906 with the requested trained prediction logic. In one implementation, the prediction logic retrieve response may include data such as a response identifier, the requested prediction logic trained structure, and/or the like. In one embodiment, the ML repository may provide the following example prediction logic retrieve response, substantially in the form of a HTTP(S) POST message including XML-formatted data, as provided below:

```
POST /prediction_logic_retrieve_response.php HTTP/1.1
Host: www.server.com
Content-Type: Application/XML
Content-Length: 667
<?XML version = “1.0” encoding = “UTF-8”?>
<prediction_logic_retrieve_response>
    <response_identifier>ID_response_14</response_identifier>
    <prediction_logic_trained_structure>
        optimal policy datastructure
    </prediction_logic_trained_structure>
</prediction_logic_retrieve_response>
```

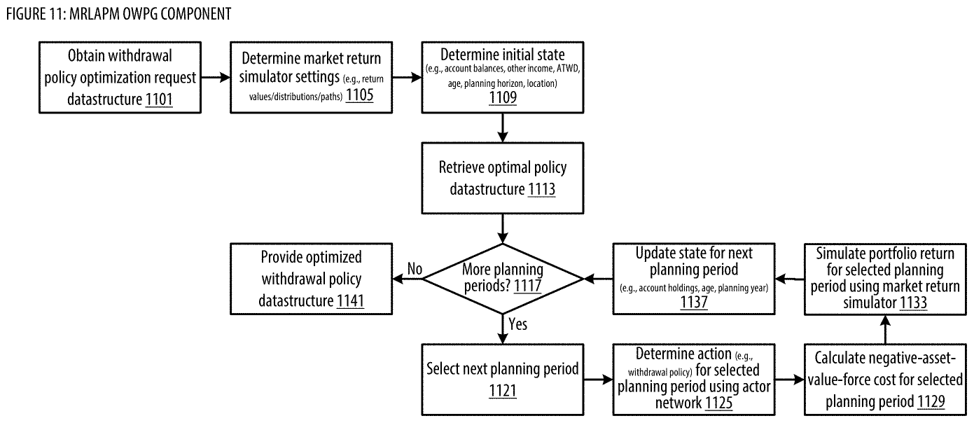

An optimized withdrawal policy generating (OWPG) component 953 may utilize data provided in the withdrawal policy optimization input and/or the retrieved prediction logic to generate an optimized withdrawal policy datastructure. See FIG. 11 for additional details regarding the OWPG component.

The MRLAPM server 906 may send a withdrawal policy optimization output 957 to the user client 908 to provide the user with the optimized withdrawal policy datastructure. In one implementation, the withdrawal policy optimization output may include data such as a response identifier, the optimized withdrawal policy datastructure, and/or the like. In one embodiment, the MRLAPM server may provide the following example withdrawal policy optimization output, substantially in the form of a HTTP(S) POST message including XML-formatted data, as provided below:

```
POST /withdrawal_policy_optimization_output.php HTTP/1.1
Host: www.server.com
Content-Type: Application/XML
Content-Length: 667
<?XML version = “1.0” encoding = “UTF-8”?>
<withdrawal_policy_optimization_output>
    <response_identifier>ID_response_13</response_identifier>
        <optimized_withdrawal_policy_datastructure>
            <period_withdrawal_policy>
                <year>1</year>
                <accounts>
                    <account>
                        <account_identifier>ID_account_1</account_identifier>
                        <account_type>BROKERAGE</account_type>
                        <annual_withdrawal_amount>$40,000</annual_withdrawal_amount>
                    </account>
                    <account>
                        <account_identifier>ID_account_2</account_identifier>
                        <account_type>TDA</account_type>
                        <annual_withdrawal_amount>$30,000</annual_withdrawal_amount>
                    </account>
                    <account>
                        <account_identifier>ID_account_3</account_identifier>
                        <account_type>ROTH</account_type>
                        <annual_withdrawal_amount>$5,000</annual_withdrawal_amount>
                    </account>
                </accounts>
            </period_withdrawal_policy>
            <period_withdrawal_policy>
                <year>2</year>
                <accounts>
                    <account>
                        <account_identifier>ID_account_1</account_identifier>
                        <account_type>BROKERAGE</account_type>
                        <annual_withdrawal_amount>$35,000</annual_withdrawal_amount>
                    </account>
                    <account>
                        <account_identifier>ID_account_2</account_identifier>
                        <account_type>TDA</account_type>
                        <annual_withdrawal_amount>$30,000</annual_withdrawal_amount>
                    </account>
                    <account>
                        <account_identifier>ID_account_3</account_identifier>
                        <account_type>ROTH</account_type>
                        <annual_withdrawal_amount>$5,000</annual_withdrawal_amount>
                    </account>
                </accounts>
            </period_withdrawal_policy>
            ...
            <period_withdrawal_policy>
                <year>5</year>
                <accounts>
                    <account>
                        <account_identifier>ID_account_1</account_identifier>
                        <account_type>BROKERAGE</account_type>
                        <annual_withdrawal_amount>$35,000</annual_withdrawal_amount>
                    </account>
                    <account>
                        <account_identifier>ID_account_2</account_identifier>
                        <account_type>TDA</account_type>
                        <annual_withdrawal_amount>$30,000</annual_withdrawal_amount>
                    </account>
                    <account>
                        <account_identifier>ID_account_3</account_identifier>
                        <account_type>ROTH</account_type>
                        <annual_withdrawal_amount>$205,000</annual_withdrawal_amount>
                    </account>
                </accounts>
            </period_withdrawal_policy>
            ...
        </optimized_withdrawal_policy_datastructure>
</withdrawal_policy_optimization_output>
```

FIG. 10 shows non-limiting, example embodiments of a logic flow illustrating a machine learning training (MLT) component for the MRLAPM. In FIG. 10, a machine learning (ML) training request may be obtained at 1001. For example, the ML training request may be obtained as a result of an administrative user initiating training of a prediction logic that provides optimized withdrawal policy recommendations.

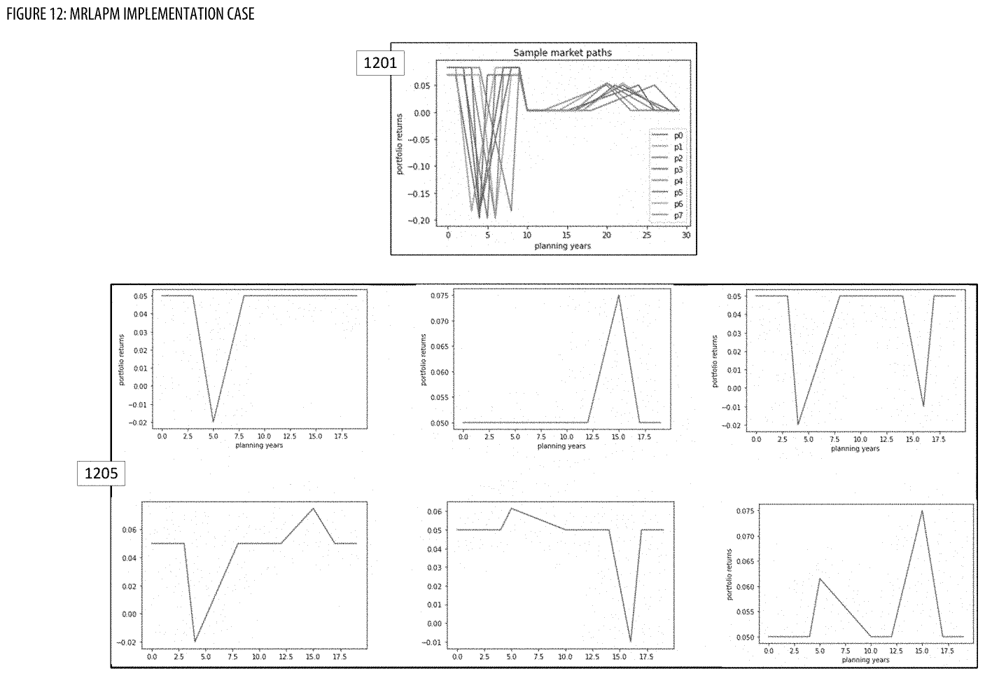

Market return simulator settings for a market return simulator may be determined at 1005. In one embodiment, the market return simulator may utilize constant return values to simulate market returns. For example, the market return simulator settings may specify an overall return value, a return value for equities, a return value for bonds, a return value for cash, and/or the like (e.g., annual percentage return values, return values based on any other planning period length). In another embodiment, the market return simulator may utilize samples from a probabilistic distribution to simulate market returns. For example, the market return simulator settings may specify a probabilistic distribution (e.g., Gaussian distribution) and/or probabilistic distribution configuration settings (e.g., mean and standard deviation). In another embodiment, the market return simulator may utilize samples from a set of market return paths to simulate market returns. For example, the market return simulator settings may specify a market return path shape and/or market return path configuration settings (e.g., mean and standard deviation). See chart 1201 in FIG. 12 for an example set of sample market return paths with specified mean and standard deviation. In another example, the market return simulator settings may specify a set of predefined market return paths (e.g., to reduce the complexity of simulating the market return from a stochastic process). See charts 1205 in FIG. 12 for an example set of sample predefined market return paths. In one implementation, the ML training request may be parsed (e.g., using PHP commands) to determine the market return simulator settings (e.g., based on the value of the market_return_simulator_settings field).

An optimal policy reward function may be determined at 1009. In one embodiment, the optimal policy reward function may specify a reward (e.g., a total reward) for a training sample associated with taking a set of actions given an initial state for the training sample. In one implementation, the ML training request may be parsed (e.g., using PHP commands) to determine the optimal policy reward function (e.g., based on the value of the optimal_policy_reward_function field). For example, an optimal policy reward function similar to the following may be utilized:

total reward = intermediate years rewards + final year reward
intermediate years rewards: 1 if the ATWD is met, penalty otherwise
final year reward: sum of market values of the accounts
where:
ATWD may include ATWD constant and/or ATWD
variable (e.g., the sum of ATWD constant and
ATWD variable)

In another example, an optimal policy reward function similar to the following may be utilized:

```
total reward = intermediate years rewards + final year reward
intermediate years rewards: IReward(t)
final year reward: TReward
where:
Intermediate Rewards (sigmoid with penalty) IReward(t):
if $ withdrawal > ATWD:
    IReward(t) = sigmoid($ withdrawal − ATWD), t=1, 2, ..., T
else:
    IReward(t) = −100
Bequest Reward BReward(T):
if $ withdrawal > ATWD:
    BReward(T) = sigmoid(bequest − lower bound of bequest)
else:
    BReward(T) = −100
Terminal Reward TReward:
TReward = IReward(T) + lambda * BReward(T)
where lambda is the balance between the desire for certain lifestyle and bequest
where:
ATWD may include ATWD constant and/or ATWD variable (e.g., the sum of ATWD constant and
ATWD variable)
```

A training convergence threshold may be determined at 1013. For example, a threshold change in average rewards between training iterations may be utilized as the training convergence threshold. In one embodiment, the training convergence threshold may be used to determine when an optimal policy is learned (e.g., parameters of the optimal policy converge) and training should end. In one implementation, a configuration setting associated with the utilized ML technique may be checked to determine the training convergence threshold.

A determination may be made at 1017 whether there remain action networks to utilize. In one embodiment, an action network (e.g., actor network and/or critic network of an RL agent) may be initialized with a random seed. Since the problem is not convex, an action network may be trapped in a local minimum (e.g., resulting in poor performance). Accordingly, in some embodiments, a plurality of action networks with different seeds may be utilized to increase the exploration range. In one implementation, the ML training request may be parsed (e.g., using PHP commands) to determine the number of action networks to utilize (e.g., based on the value of the number_of_networks field). If there remain action networks to utilize, the next action network to utilize may be selected for processing at 1021. It is to be understood that, in some implementations, action networks may be processed in parallel to increase training speed. The selected action network may be initialized with a seed at 1025. In one implementation, a random seed may be utilized to initialize the selected action network. For example, the selected action network's weights may be initialized using PyTorch's uniform distributed initialization technique.

A determination may be made at 1029 whether an optimal policy was learned by the selected action network. In one implementation, the optimal policy is learned when parameters of the optimal policy converge (e.g., based on the training convergence threshold). In one embodiment, the optimal policy may be structured to minimize the cumulative negative-asset-value-force costs within a time horizon, while satisfying minimum income requirements and/or maximining the market value of account holdings at the end of the time horizon. In some embodiments, the optimal policy may be structured to satisfy other objectives such as maximizing withdrawal amount, minimizing the volatility of withdrawal amount, minimizing the probability of premature account holdings depletion, maximizing the estate size, and/or the like.

If the optimal policy was not learned yet, a determination may be made at 1033 whether to generate more training samples. In one embodiment, some number N (e.g., 1000) of training samples may be utilized during each training iteration. In one implementation, new training samples may be generated for each training iteration. In another implementation, previously generated training samples may be reused (e.g., in whole, in part in combination with some newly generated training samples, shared among the plurality of actions networks) during subsequent training iterations. For example, a configuration setting associated with the utilized ML technique may be checked to determine the number N of training samples to generate.

If more training samples should be generated, an initial state for a training sample may be determined at 1037. For example, a state may comprise data such as user information (e.g., age, filing status, location), accounts information, incomes information, retirement information (e.g., retirement year, planning horizon, ATWD constant (e.g., desired annual withdrawals), ATWD variable (e.g., additional withdrawals for specific events (e.g., purchasing a vacation house)), bequest amount), and/or the like. In one embodiment, an initial state may be selected from a set of specified possible examples. In another embodiment, an initial state may be generated randomly (e.g., within specified bounds). In one implementation, the ML training request may be parsed (e.g., using PHP commands) to determine the initial state for the training sample (e.g., based on the values of the training_sample_configuration fields).

A determination may be made at 1041 whether there remain more planning periods to process (e.g., based on the planning horizon) for the training sample. In one implementation, each of the planning periods (e.g., from retirement start year planning period 0 to final year T) for the training sample may be processed. If there remain more planning periods to process for the training sample, the next planning period may be selected for processing at 1045.

An action for the selected planning period may be determined using the actor network at 1049. In one embodiment, the action is a withdrawal policy that specifies withdrawal amounts for each of the accounts and that is determined using the actor network given the current state (e.g., the initial state for planning period 0, an updated state for subsequent planning periods). In one implementation, the actor network may take the current state as input and may output a set of account withdrawal actions (e.g., amount to withdraw from brokerage account during the selected planning period, amount to withdraw from TDA account during the selected planning period, and amount to withdraw from ROTH account during the selected planning period). These account withdrawal actions may be further scaled to observe various constraints and/or bounds (e.g., RMDs). For example, a set of constraints similar to the following may be utilized:

Constraints:
sum(withdrawals) − negative-asset-value-force = ATWD − other incomes
RMD <= withdrawal <= account value
where:
ATWD may include ATWD constant and/or ATWD variable (e.g., the sum of ATWD constant and
ATWD variable)

A negative-asset-value-force cost for the selected planning period may be calculated at 1053. In one embodiment, the negative-asset-value-force cost for the selected planning period may be calculated using a negative-asset-value-force calculator component based on the action for the selected planning period and information regarding negative-asset-value-forces (e.g., account transaction fees, account withdrawal penalties, filing information). In one implementation, the negative-asset-value-force cost for the selected planning period may be calculated using online API calls. In another implementation, the negative-asset-value-force cost for the selected planning period may be calculated using a machine learning estimator.

A reward for the selected planning period may be determined using the optimal policy reward function at 1057. For example, an intermediate year reward may be calculated for intermediate years (e.g., t<T). In another example, a final year reward may be calculated for the final year (e.g., t=T). In one implementation, the withdrawal policy for the selected planning period adjusted by the negative-asset-value-force cost for the selected planning period may be evaluated using the optimal policy reward function to determine the reward for the selected planning period.

A portfolio return for the selected planning period may be simulated using the market return simulator at 1061. In one embodiment, the market return simulator may simulate an overall market return. In another embodiment, the market return simulator may simulate separate market returns for different asset types (e.g., equities, bonds, cash). In one implementation, each of the accounts may be analyzed using the simulated market return(s) and/or a respective account's asset type allocation and/or the respective account's negative-asset-value-force cost to calculate the respective account's holdings (e.g., account balance) for the next planning period (e.g., t+1). For example, an account's holdings for the next planning period may be calculated as follows:

Account holdings for planning period t+1:
Holdings(t+1) = (Holdings(t) − withdrawal(t) −
negative-asset-value-force cost(t)) * (1
+ simulated return

In another example, an account's holdings for the next planning period may be calculated as follows:

```
Account holdings for planning period t+1:
Holdings(t+1) =
    ((Holdings_{equities}(t) − withdrawal_{equities}(t) − negative-asset-value-force cost_{equities}(t))
* (1 + simulated return_{equities})) +
    ((Holdings_{bonds}(t) − withdrawal_{bonds}(t) − negative-asset-value-force cost_{bonds}(t)) * (1
+ simulated return_{bonds})) +
    ((Holdings_{cash}(t) − withdrawal_{cash}(t) − negative-asset-value-force cost_{cash}(t)) * (1 +
simulated return_{cash}))
In one implementation, withdrawals for different asset types may be proportional to a
respective asset type’s account allocation percentage (e.g., if the account comprises
50% equities, 30% bonds and 20% cash, for each $100 withdrawal indicated by the
withdrawal policy for the account 50$ are withdrawn from equities, $30 are withdrawn
from bonds and $20 are withdrawn from cash).
```

The current state may be updated for the next planning period at 1065. For example, account holdings for the next planning period may be updated to reflect the calculated account holdings. In another example, user's age, planning year, and/or the like may be updated. In one implementation, a current state datastructure holding data regarding the current state (e.g., having data fields similar to those discussed with regard to the training_sample_configuration field of the ML training request) may be updated (e.g., using PHP commands).

If there do not remain more planning periods to process for the training sample, the training sample may be generated at 1069. In one implementation, the training sample may be a set of training sample datastructures that each comprise the following data fields: {state, action, reward} for each individual planning period. For example, training data similar to the following may be specified:

state: variables including a) market values in each
of the accounts, b) number of years
in the planning period (i.e., t-th year), and c) user’s age at year t
action: withdrawal amounts from the accounts
reward: scalar value from the optimal policy reward function

If enough training samples were generated, an RL technique may be used on the training samples to learn the optimal policy at 1073. For example, the proximal policy optimization (PPO) RL technique may be used (e.g., specified via the ML training request (e.g., based on the value of the RL_technique_identifier field)). In one implementation, the PPO technique may be used on the training samples to update the actor and/or critic networks. For example, the PPO technique may be used as follows:

Update the actor and critic networks by Minimize(Training_loss_function)
Training_loss_function = Critic_loss + Actor_loss + Entropy_loss
where:
Critic_loss is the Mean Squared Error (MSE) between rewards and critic values, and
critic values are the outputs from the critic network given states as inputs
Actor_loss = −1 * (New policy probability / old policy probability) * (rewards − state
value)
Entropy_loss is added to encourage exploration

If the optimal policy was learned by the selected action network, an optimal policy rank for the selected action network may be determined at 1077. For example, average rewards may be used to determine optimal policy ranks of action networks. In one implementation, average rewards during the last training iteration may be used as the optimal policy rank for the selected action network. In another implementation, average rewards obtained by testing on a set of testing samples may be used as the optimal policy rank for the selected action network. Once the action networks to utilize have been ranked, an action network with the highest optimal policy rank may be selected at 1081. In one embodiment, the action network with the highest optimal policy rank may be expected to have the best performance.

An optimal policy datastructure (e.g., corresponding to the selected action network) may be stored at 1085. In one implementation, the optimal policy datastructure may comprise the parameters (e.g., structure (e.g., comprising network structure and model weights for each layer) of the actor network and/or critic network) of the optimal policy and may define the prediction logic. For example, the optimal policy datastructure (e.g., prediction logic structure that defines the prediction logic) may be stored (e.g., via PyTorch using the .pt file extension) in the ML table 1419j.

FIG. 11 shows non-limiting, example embodiments of a logic flow illustrating an optimized withdrawal policy generating (OWPG) component for the MRLAPM. In FIG. 11, a withdrawal policy optimization request datastructure may be obtained at 1101. For example, the withdrawal policy optimization request datastructure may be obtained as a result of a user sending a withdrawal policy optimization input to facilitate obtaining an optimized withdrawal policy datastructure.

Market return simulator settings (e.g., return values/distributions/paths) may be determined at 1105. In one embodiment, the market return simulator may utilize constant return values to simulate market returns. In another embodiment, the market return simulator may utilize samples from a probabilistic distribution to simulate market returns. In another embodiment, the market return simulator may utilize samples from a set of market return paths to simulate market returns. In one implementation, the withdrawal policy optimization request datastructure may be parsed (e.g., using PHP commands) to determine the market return simulator settings (e.g., based on the value of the market_return_simulator_settings field). For example, the user may specify an asset types mix (e.g., 20% equities and 80% bonds) of the user's retirement portfolio and/or market conditions (e.g., poor market) for which to generate an optimized withdrawal policy.

An initial state associated with the user may be determined at 1109. For example, a state may comprise data such as user information (e.g., age, filing status, location), accounts information, incomes information, retirement information (e.g., retirement year, planning horizon, ATWD constant (e.g., desired annual withdrawals), ATWD variable (e.g., additional withdrawals for specific events (e.g., purchasing a vacation house)), bequest amount), and/or the like. In one implementation, the withdrawal policy optimization request datastructure may be parsed (e.g., using PHP commands) to determine the initial state associated with (e.g., specified by) the user (e.g., based on the value of the initial_state field).

An optimal policy datastructure may be retrieved at 1113. In one embodiment, the optimal policy datastructure may comprise data fields that specify the structure of a prediction logic (e.g., an actor ANN) that corresponds to an optimal policy that provides an optimized withdrawal policy. In one implementation, the withdrawal policy optimization request datastructure may be parsed (e.g., using PHP commands) to determine the optimal policy datastructure specified by the user (e.g., based on the value of the prediction_logic_identifier field) and/or the specified optimal policy datastructure may be retrieved from a repository. In another implementation, a default optimal policy datastructure (e.g., overall, for a specific type of user, for a specific market condition, for a specific asset types mix, and/or the like) may be retrieved from a repository.

A determination may be made at 1117 whether there remain more planning periods to process (e.g., based on the planning horizon). In one implementation, each of the planning periods (e.g., from retirement start year planning period 0 to final year T) may be processed. If there remain more planning periods to process, the next planning period may be selected for processing at 1121.

An action for the selected planning period may be determined using the retrieved actor network at 1125. In one embodiment, the action is a withdrawal policy that specifies withdrawal amounts for each of the accounts and that is determined using the actor network given the current state (e.g., the initial state for planning period 0, an updated state for subsequent planning periods). In one implementation, the actor network may take the current state as input and may output a set of account withdrawal actions (e.g., amount to withdraw from brokerage account during the selected planning period, amount to withdraw from TDA account during the selected planning period, and amount to withdraw from ROTH account during the selected planning period). These account withdrawal actions may be further scaled to observe various constraints and/or bounds (e.g., RMDs). For example, a set of constraints similar to the following may be utilized:

Constraints:
sum(withdrawals) − negative-asset-value-force = ATWD − other incomes
RMD <= withdrawal <= account value
where:
ATWD may include ATWD constant and/or ATWD
variable (e.g., the sum of ATWD constant and
ATWD variable)

A negative-asset-value-force cost for the selected planning period may be calculated at 1129. In one embodiment, the negative-asset-value-force cost for the selected planning period may be calculated using a negative-asset-value-force calculator component based on the action for the selected planning period and information regarding negative-asset-value-forces (e.g., account transaction fees, account withdrawal penalties, filing information). In one implementation, the negative-asset-value-force cost for the selected planning period may be calculated using online API calls. In another implementation, the negative-asset-value-force cost for the selected planning period may be calculated using a machine learning estimator.

A portfolio return for the selected planning period may be simulated using the market return simulator at 1133. In one embodiment, the market return simulator may simulate an overall market return. In another embodiment, the market return simulator may simulate separate market returns for different asset types (e.g., equities, bonds, cash). In one implementation, each of the accounts may be analyzed using the simulated market return(s) and/or a respective account's asset type allocation and/or the respective account's negative-asset-value-force cost to calculate the respective account's holdings for the next planning period (e.g., t+1).

The current state may be updated for the next planning period at 1137. For example, account holdings for the next planning period may be updated to reflect the calculated account holdings. In another example, user's age, planning year, and/or the like may be updated. In one implementation, a current state datastructure holding data regarding the current state (e.g., having data fields similar to those discussed with regard to the initial_state field of the withdrawal policy optimization request datastructure) may be updated (e.g., using PHP commands).

An optimized withdrawal policy datastructure may be provided at 1141. For example, the optimized withdrawal policy datastructure may be provided to the user via a withdrawal policy optimization output. In one embodiment, the optimized withdrawal policy datastructure may comprise the set of optimized actions recommended by the agent network for the user based on the market return simulator settings and the initial state associated with the user. In one implementation, the optimized withdrawal policy datastructure may comprise a set of period withdrawal policy datastructures, with each period withdrawal policy datastructure comprising a set of optimized actions for a planning period (e.g., year).

FIG. 12 shows non-limiting, example embodiments of implementation case(s) for the MRLAPM. In FIG. 12, exemplary market return paths are illustrated. At 1201, an example set of sample market return paths with specified mean and standard deviation are shown. At 1205, an example set of sample predefined market return paths are shown.

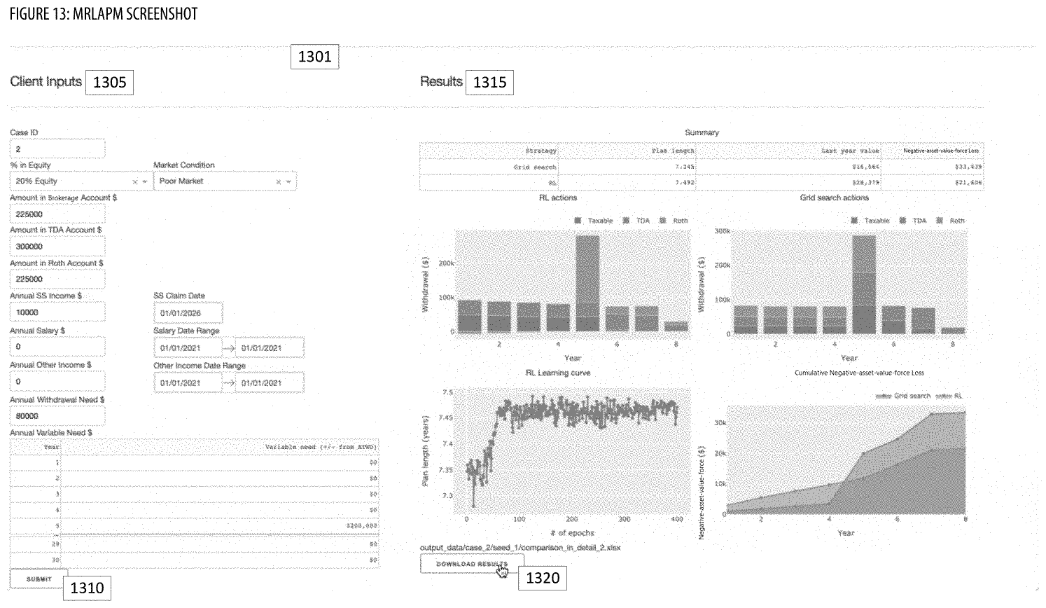

FIG. 13 shows non-limiting, example embodiments of a screenshot illustrating user interface(s) of the MRLAPM. In FIG. 13, an exemplary user interface (e.g., for a mobile device, for a website) for sending a withdrawal policy optimization input and obtaining an optimized withdrawal policy datastructure is illustrated. Screen 1301 shows that a user may utilize a set of client inputs widgets 1305 to specify market return simulator settings and/or an initial state. The user may utilize a submit widget 1310 to send the withdrawal policy optimization input. The user may utilize a set of results widgets 1315 to view information regarding provided optimized withdrawal policy. The user may utilize a download results widget 1320 to obtain the optimized withdrawal policy datastructure (e.g., as an Excel spreadsheet).

### Additional Alternative Embodiment Examples

The following alternative example embodiments provide a number of variations of some of the already discussed principles for expanded color on the abilities of the MRLAPM.

In some alternative embodiments, optimized withdrawal policy recommendations provided by an actor network may be adjusted based on optimal order parameters recommendations. For example, recommendations regarding how account holdings should be adjusted may be provided.

In some alternative embodiments, information regarding how deviation from optimized withdrawal policy recommendations change output from optimal may be provided using the actor network. For example, information regarding what a user would lose by not using annuities may be provided.

Additional embodiments may include:
1. An artificial intelligence-based order optimization recommendation engine generating apparatus, comprising:
at least one memory;
a component collection stored in the at least one memory;
at least one processor disposed in communication with the at least one memory, the at least one processor executing processor-executable instructions from the component collection, the component collection storage structured with processor-executable instructions, comprising:
   obtain, via the at least one processor, a machine learning (ML) training request datastructure, in which the ML training request datastructure is structured to specify a set of agent profile datastructures and an agent sample ranking function, in which an agent profile datastructure is structured to specify an agent's episodic holdings, trades and cashflow data at a bucket level for a training period;
   determine, via the at least one processor, an agent samples range, in which the agent samples range is structured as a set of subsequences of agents' episodic holdings, trades and cashflow data;
   generate, via the at least one processor, a set of inverse reinforcement learning (IRL) training sample datastructures, in which an IRL training sample datastructure is structured to specify a pairwise comparison of rankings of a pair of agents during a subsequence in the set of subsequences as determined using the agent sample ranking function;
   determine, via the at least one processor, a reward function structure to use for inverse reinforcement learning;
   determine, via the at least one processor, an optimal reward function having the determined reward function structure using an IRL technique on the set of IRL training sample datastructures, in which the optimal reward function is structured to have parameters that keep pairwise agent ranking orders specified in the set of IRL training sample datastructures;
   determine, via the at least one processor, an optimal policy using a reinforcement learning (RL) technique and the optimal reward function, in which the optimal policy provides trading recommendations based on current holdings and an order constraint value; and
   store, via the at least one processor, an optimal policy datastructure, in which the optimal policy datastructure is structured to specify a set of parameters that define the structure of the optimal policy.
2. The apparatus of embodiment 1, in which an agent profile datastructure of an agent is structured to correspond to a fund trading profile of a fund.
3. The apparatus of embodiment 2, in which funds corresponding to the set of agent profile datastructures utilize the same benchmark portfolio as a fund performance benchmark.
4. The apparatus of embodiment 1, in which an agent's episodic holdings, trades and cashflow data is for an episode length that is one of: a day, a week, a month, a quarter, a year.
5. The apparatus of embodiment 1, in which a bucket is one of: an individual stock, a sector, a portfolio.
6. The apparatus of embodiment 1, in which the training period is one of: a month, a quarter, a year, a plurality of years.
7. The apparatus of embodiment 1, in which the agent sample ranking function is one of: fund return, Sharpe ratio, Sortino ratio.
8. The apparatus of embodiment 1, in which subsequences in the set of subsequences are structured to have different subsequence lengths.
9. The apparatus of embodiment 1, in which subsequences in the set of subsequences are structured to have overlapping date ranges.
10. The apparatus of embodiment 1, in which an IRL training sample datastructure is structured to comprise: a tuple specifying two agent-subsequence identifiers, and a binary value specifying a pairwise agent ranking order associated with the two agent-subsequence identifiers.
11. The apparatus of embodiment 1, in which the reward function structure to use for inverse reinforcement learning is a parametric T-REX function.
12. The apparatus of embodiment 11, in which the parametric T-REX function is structured to have a set of four parameters {ρ, η, λ, ω}.
13. The apparatus of embodiment 1, in which the IRL technique is T-REX.
14. The apparatus of embodiment 1, in which the RL technique is G-Learner.
15. The apparatus of embodiment 1, in which the set of parameters that define the structure of the optimal policy comprises three parameters ũₜ, \tilde{v}ₜ, \tilde{Σ}ₚ.
16. An artificial intelligence-based order optimization recommendation engine generating processor-readable, non-transient medium, the medium storing a component collection, the component collection storage structured with processor-executable instructions comprising:
   obtain, via the at least one processor, a machine learning (ML) training request datastructure, in which the ML training request datastructure is structured to specify a set of agent profile datastructures and an agent sample ranking function, in which an agent profile datastructure is structured to specify an agent's episodic holdings, trades and cashflow data at a bucket level for a training period;
   determine, via the at least one processor, an agent samples range, in which the agent samples range is structured as a set of subsequences of agents' episodic holdings, trades and cashflow data;
   generate, via the at least one processor, a set of inverse reinforcement learning (IRL) training sample datastructures, in which an IRL training sample datastructure is structured to specify a pairwise comparison of rankings of a pair of agents during a subsequence in the set of subsequences as determined using the agent sample ranking function;
   determine, via the at least one processor, a reward function structure to use for inverse reinforcement learning;
   determine, via the at least one processor, an optimal reward function having the determined reward function structure using an IRL technique on the set of IRL training sample datastructures, in which the optimal reward function is structured to have parameters that keep pairwise agent ranking orders specified in the set of IRL training sample datastructures;
   determine, via the at least one processor, an optimal policy using a reinforcement learning (RL) technique and the optimal reward function, in which the optimal policy provides trading recommendations based on current holdings and an order constraint value; and
   store, via the at least one processor, an optimal policy datastructure, in which the optimal policy datastructure is structured to specify a set of parameters that define the structure of the optimal policy.
17. The medium of embodiment 16, in which an agent profile datastructure of an agent is structured to correspond to a fund trading profile of a fund.
18. The medium of embodiment 17, in which funds corresponding to the set of agent profile datastructures utilize the same benchmark portfolio as a fund performance benchmark.
19. The medium of embodiment 16, in which an agent's episodic holdings, trades and cashflow data is for an episode length that is one of: a day, a week, a month, a quarter, a year.
20. The medium of embodiment 16, in which a bucket is one of: an individual stock, a sector, a portfolio.
21. The medium of embodiment 16, in which the training period is one of: a month, a quarter, a year, a plurality of years.
22. The medium of embodiment 16, in which the agent sample ranking function is one of: fund return, Sharpe ratio, Sortino ratio.
23. The medium of embodiment 16, in which subsequences in the set of subsequences are structured to have different subsequence lengths.
24. The medium of embodiment 16, in which subsequences in the set of subsequences are structured to have overlapping date ranges.
25. The medium of embodiment 16, in which an IRL training sample datastructure is structured to comprise: a tuple specifying two agent-subsequence identifiers, and a binary value specifying a pairwise agent ranking order associated with the two agent-subsequence identifiers.
26. The medium of embodiment 16, in which the reward function structure to use for inverse reinforcement learning is a parametric T-REX function.
27. The medium of embodiment 26, in which the parametric T-REX function is structured to have a set of four parameters {ρ, η, λ, ω}.
28. The medium of embodiment 16, in which the IRL technique is T-REX.
29. The medium of embodiment 16, in which the RL technique is G-Learner.
30. The medium of embodiment 16, in which the set of parameters that define the structure of the optimal policy comprises three parameters ũₜ, \tilde{v}ₜ, \tilde{Σ}ₚ.
31. An artificial intelligence-based order optimization recommendation engine generating processor-implemented system, comprising:
means to store a component collection;
means to process processor-executable instructions from the component collection, the component collection storage structured with processor-executable instructions including:
   obtain, via the at least one processor, a machine learning (ML) training request datastructure, in which the ML training request datastructure is structured to specify a set of agent profile datastructures and an agent sample ranking function, in which an agent profile datastructure is structured to specify an agent's episodic holdings, trades and cashflow data at a bucket level for a training period;
   determine, via the at least one processor, an agent samples range, in which the agent samples range is structured as a set of subsequences of agents' episodic holdings, trades and cashflow data;
   generate, via the at least one processor, a set of inverse reinforcement learning (IRL) training sample datastructures, in which an IRL training sample datastructure is structured to specify a pairwise comparison of rankings of a pair of agents during a subsequence in the set of subsequences as determined using the agent sample ranking function;
   determine, via the at least one processor, a reward function structure to use for inverse reinforcement learning;
   determine, via the at least one processor, an optimal reward function having the determined reward function structure using an IRL technique on the set of IRL training sample datastructures, in which the optimal reward function is structured to have parameters that keep pairwise agent ranking orders specified in the set of IRL training sample datastructures;
   determine, via the at least one processor, an optimal policy using a reinforcement learning (RL) technique and the optimal reward function, in which the optimal policy provides trading recommendations based on current holdings and an order constraint value; and
   store, via the at least one processor, an optimal policy datastructure, in which the optimal policy datastructure is structured to specify a set of parameters that define the structure of the optimal policy.
32. The system of embodiment 31, in which an agent profile datastructure of an agent is structured to correspond to a fund trading profile of a fund.
33. The system of embodiment 32, in which funds corresponding to the set of agent profile datastructures utilize the same benchmark portfolio as a fund performance benchmark.
34. The system of embodiment 31, in which an agent's episodic holdings, trades and cashflow data is for an episode length that is one of: a day, a week, a month, a quarter, a year.
35. The system of embodiment 31, in which a bucket is one of: an individual stock, a sector, a portfolio.
36. The system of embodiment 31, in which the training period is one of: a month, a quarter, a year, a plurality of years.
37. The system of embodiment 31, in which the agent sample ranking function is one of: fund return, Sharpe ratio, Sortino ratio.
38. The system of embodiment 31, in which subsequences in the set of subsequences are structured to have different subsequence lengths.
39. The system of embodiment 31, in which subsequences in the set of subsequences are structured to have overlapping date ranges.
40. The system of embodiment 31, in which an IRE training sample datastructure is structured to comprise: a tuple specifying two agent-subsequence identifiers, and a binary value specifying a pairwise agent ranking order associated with the two agent-subsequence identifiers.
41. The system of embodiment 31, in which the reward function structure to use for inverse reinforcement learning is a parametric T-REX function.
42. The system of embodiment 41, in which the parametric T-REX function is structured to have a set of four parameters {ρ, η, λ, ω}.
43. The system of embodiment 31, in which the IRL technique is T-REX.
44. The system of embodiment 31, in which the RL technique is G-Learner.
45. The system of embodiment 31, in which the set of parameters that define the structure of the optimal policy comprises three parameters ũₜ, \tilde{v}ₜ, \tilde{Σ}ₚ.
46. An artificial intelligence-based order optimization recommendation engine generating processor-implemented process, including processing processor-executable instructions via at least one processor from a component collection stored in at least one memory, the component collection storage structured with processor-executable instructions comprising:
   obtain, via the at least one processor, a machine learning (ML) training request datastructure, in which the ML training request datastructure is structured to specify a set of agent profile datastructures and an agent sample ranking function, in which an agent profile datastructure is structured to specify an agent's episodic holdings, trades and cashflow data at a bucket level for a training period;
   determine, via the at least one processor, an agent samples range, in which the agent samples range is structured as a set of subsequences of agents' episodic holdings, trades and cashflow data;
   generate, via the at least one processor, a set of inverse reinforcement learning (IRL) training sample datastructures, in which an IRE training sample datastructure is structured to specify a pairwise comparison of rankings of a pair of agents during a subsequence in the set of subsequences as determined using the agent sample ranking function;
   determine, via the at least one processor, a reward function structure to use for inverse reinforcement learning;
   determine, via the at least one processor, an optimal reward function having the determined reward function structure using an IRL technique on the set of IRL training sample datastructures, in which the optimal reward function is structured to have parameters that keep pairwise agent ranking orders specified in the set of IRL training sample datastructures;
   determine, via the at least one processor, an optimal policy using a reinforcement learning (RL) technique and the optimal reward function, in which the optimal policy provides trading recommendations based on current holdings and an order constraint value; and
   store, via the at least one processor, an optimal policy datastructure, in which the optimal policy datastructure is structured to specify a set of parameters that define the structure of the optimal policy.
47. The process of embodiment 46, in which an agent profile datastructure of an agent is structured to correspond to a fund trading profile of a fund.
48. The process of embodiment 47, in which funds corresponding to the set of agent profile datastructures utilize the same benchmark portfolio as a fund performance benchmark.
49. The process of embodiment 46, in which an agent's episodic holdings, trades and cashflow data is for an episode length that is one of: a day, a week, a month, a quarter, a year.
50. The process of embodiment 46, in which a bucket is one of: an individual stock, a sector, a portfolio.
51. The process of embodiment 46, in which the training period is one of: a month, a quarter, a year, a plurality of years.
52. The process of embodiment 46, in which the agent sample ranking function is one of: fund return, Sharpe ratio, Sortino ratio.
53. The process of embodiment 46, in which subsequences in the set of subsequences are structured to have different subsequence lengths.
54. The process of embodiment 46, in which subsequences in the set of subsequences are structured to have overlapping date ranges.
55. The process of embodiment 46, in which an IRL training sample datastructure is structured to comprise: a tuple specifying two agent-subsequence identifiers, and a binary value specifying a pairwise agent ranking order associated with the two agent-subsequence identifiers.
56. The process of embodiment 46, in which the reward function structure to use for inverse reinforcement learning is a parametric T-REX function.
57. The process of embodiment 56, in which the parametric T-REX function is structured to have a set of four parameters {ρ, η, λ, ω}.
58. The process of embodiment 46, in which the IRL technique is T-REX.
59. The process of embodiment 46, in which the RL technique is G-Learner.
60. The process of embodiment 46, in which the set of parameters that define the structure of the optimal policy comprises three parameters ũₜ, \tilde{v}ₜ, \tilde{Σ}ₚ.
101. An artificial intelligence-based optimized withdrawal policy recommendation engine generating apparatus, comprising:
at least one memory;
a component collection stored in the at least one memory;
at least one processor disposed in communication with the at least one memory, the at least one processor executing processor-executable instructions from the component collection, the component collection storage structured with processor-executable instructions, comprising:
   obtain, via the at least one processor, a machine learning (ML) training request datastructure, in which the ML training request datastructure is structured to specify an optimal policy reward function and a set of training sample configuration datastructures, in which a training sample configuration datastructure is structured to specify an initial state comprising user information data fields, accounts information data fields, and retirement information data fields;
   generate, via the at least one processor, a set of training sample datastructures using the optimal policy reward function and a specified training sample configuration datastructure from the set of training sample configuration datastructures, in which the instructions to generate a training sample datastructure are structured as:
      determine, via the at least one processor, a current state associated with the specified training sample configuration datastructure for a current planning period, in which the current state is the initial state associated with the specified training sample configuration datastructure for an initial planning period, and an updated state for subsequent planning periods;
      determine, via the at least one processor, an action for the current planning period using an actor network, in which the action is a withdrawal policy for a set of user accounts, in which the actor network takes the current state as input and outputs the withdrawal policy for the current planning period;
      calculate, via the at least one processor, a negative-asset-value-force cost for the current planning period based on the action for the current planning period;
      determine, via the at least one processor, a reward value for the current planning period using the optimal policy reward function; and
      store, via the at least one processor, the current state, the action for the current planning period, and the reward value as data fields of the training sample datastructure;
   determine, via the at least one processor, an optimal policy using a reinforcement learning (RL) technique and the generated set of training sample datastructures, in which the optimal policy provides optimized withdrawal policy recommendations based on a provided initial state; and
   store, via the at least one processor, an optimal policy datastructure, in which the optimal policy datastructure is structured to specify a set of parameters that define the structure of the optimal policy.
102. The apparatus of embodiment 101, in which the optimal policy reward function is structured to specify an intermedia year reward function and a final year reward function.
103. The apparatus of embodiment 102, in which the final year reward function is structured to specify a bequest reward function.
104. The apparatus of embodiment 101, in which the user information data fields comprise: user age and user location.
105. The apparatus of embodiment 101, in which the accounts information data fields comprise: account type and account holdings for the set of user accounts.
106. The apparatus of embodiment 101, in which the retirement information data fields comprise: retirement year, planning horizon, and constant periodic withdrawal amount.
107. The apparatus of embodiment 106, in which the retirement information data fields further comprise at least one of: variable periodic withdrawal amount, bequest amount.
108. The apparatus of embodiment 101, in which an initial state further comprises incomes information data fields, and in which the incomes information data fields comprise: periodic income amount and income date range for a set of user incomes.
109. The apparatus of embodiment 101, in which the ML training request datastructure is structured to specify market return simulator settings data fields.
110. The apparatus of embodiment 101, in which the negative-asset-value-force cost for the current planning period is calculated using a set of online API calls.
111. The apparatus of embodiment 101, in which the negative-asset-value-force cost for the current planning period is calculated using a machine learning estimator.
112. The apparatus of embodiment 101, in which the reward value for the current planning period is determined by evaluating the withdrawal policy for the current planning period adjusted by the negative-asset-value-force cost for the current planning period.
113. The apparatus of embodiment 101, in which the instructions to generate the training sample datastructure are further structured as:
   calculate, via the at least one processor, account holdings for the set of user accounts for the next planning period based on a simulated portfolio return for the current planning period; and
   update, via the at least one processor, the current state using the calculated account holdings for the set of user accounts for the next planning period.
114. The apparatus of embodiment 101, in which the RL technique is Proximal Policy Optimization.
115. The apparatus of embodiment 114, in which the set of parameters that define the structure of the optimal policy comprises: network structure and weights for each layer of an actor network.
116. An artificial intelligence-based optimized withdrawal policy recommendation engine generating processor-readable, non-transient medium, the medium storing a component collection, the component collection storage structured with processor-executable instructions comprising:
   obtain, via the at least one processor, a machine learning (ML) training request datastructure, in which the ML training request datastructure is structured to specify an optimal policy reward function and a set of training sample configuration datastructures, in which a training sample configuration datastructure is structured to specify an initial state comprising user information data fields, accounts information data fields, and retirement information data fields;
   generate, via the at least one processor, a set of training sample datastructures using the optimal policy reward function and a specified training sample configuration datastructure from the set of training sample configuration datastructures, in which the instructions to generate a training sample datastructure are structured as:
      determine, via the at least one processor, a current state associated with the specified training sample configuration datastructure for a current planning period, in which the current state is the initial state associated with the specified training sample configuration datastructure for an initial planning period, and an updated state for subsequent planning periods;
      determine, via the at least one processor, an action for the current planning period using an actor network, in which the action is a withdrawal policy for a set of user accounts, in which the actor network takes the current state as input and outputs the withdrawal policy for the current planning period;
      calculate, via the at least one processor, a negative-asset-value-force cost for the current planning period based on the action for the current planning period;
      determine, via the at least one processor, a reward value for the current planning period using the optimal policy reward function; and
      store, via the at least one processor, the current state, the action for the current planning period, and the reward value as data fields of the training sample datastructure;
   determine, via the at least one processor, an optimal policy using a reinforcement learning (RL) technique and the generated set of training sample datastructures, in which the optimal policy provides optimized withdrawal policy recommendations based on a provided initial state; and
   store, via the at least one processor, an optimal policy datastructure, in which the optimal policy datastructure is structured to specify a set of parameters that define the structure of the optimal policy.
117. The medium of embodiment 116, in which the optimal policy reward function is structured to specify an intermedia year reward function and a final year reward function.
118. The medium of embodiment 117, in which the final year reward function is structured to specify a bequest reward function.
119. The medium of embodiment 116, in which the user information data fields comprise: user age and user location.
120. The medium of embodiment 116, in which the accounts information data fields comprise: account type and account holdings for the set of user accounts.
121. The medium of embodiment 116, in which the retirement information data fields comprise: retirement year, planning horizon, and constant periodic withdrawal amount.
122. The medium of embodiment 121, in which the retirement information data fields further comprise at least one of: variable periodic withdrawal amount, bequest amount.
123. The medium of embodiment 116, in which an initial state further comprises incomes information data fields, and in which the incomes information data fields comprise: periodic income amount and income date range for a set of user incomes.
124. The medium of embodiment 116, in which the ML training request datastructure is structured to specify market return simulator settings data fields.
125. The medium of embodiment 116, in which the negative-asset-value-force cost for the current planning period is calculated using a set of online API calls.
126. The medium of embodiment 116, in which the negative-asset-value-force cost for the current planning period is calculated using a machine learning estimator.
127. The medium of embodiment 116, in which the reward value for the current planning period is determined by evaluating the withdrawal policy for the current planning period adjusted by the negative-asset-value-force cost for the current planning period.
128. The medium of embodiment 116, in which the instructions to generate the training sample datastructure are further structured as:
   calculate, via the at least one processor, account holdings for the set of user accounts for the next planning period based on a simulated portfolio return for the current planning period; and
   update, via the at least one processor, the current state using the calculated account holdings for the set of user accounts for the next planning period.
129. The medium of embodiment 116, in which the RL technique is Proximal Policy Optimization.
130. The medium of embodiment 129, in which the set of parameters that define the structure of the optimal policy comprises: network structure and weights for each layer of an actor network.
131. An artificial intelligence-based optimized withdrawal policy recommendation engine generating processor-implemented system, comprising:
means to store a component collection;
means to process processor-executable instructions from the component collection, the component collection storage structured with processor-executable instructions including:
   obtain, via the at least one processor, a machine learning (ML) training request datastructure, in which the ML training request datastructure is structured to specify an optimal policy reward function and a set of training sample configuration datastructures, in which a training sample configuration datastructure is structured to specify an initial state comprising user information data fields, accounts information data fields, and retirement information data fields;
   generate, via the at least one processor, a set of training sample datastructures using the optimal policy reward function and a specified training sample configuration datastructure from the set of training sample configuration datastructures, in which the instructions to generate a training sample datastructure are structured as:
      determine, via the at least one processor, a current state associated with the specified training sample configuration datastructure for a current planning period, in which the current state is the initial state associated with the specified training sample configuration datastructure for an initial planning period, and an updated state for subsequent planning periods;
      determine, via the at least one processor, an action for the current planning period using an actor network, in which the action is a withdrawal policy for a set of user accounts, in which the actor network takes the current state as input and outputs the withdrawal policy for the current planning period;
      calculate, via the at least one processor, a negative-asset-value-force cost for the current planning period based on the action for the current planning period;
      determine, via the at least one processor, a reward value for the current planning period using the optimal policy reward function; and
      store, via the at least one processor, the current state, the action for the current planning period, and the reward value as data fields of the training sample datastructure;
   determine, via the at least one processor, an optimal policy using a reinforcement learning (RL) technique and the generated set of training sample datastructures, in which the optimal policy provides optimized withdrawal policy recommendations based on a provided initial state; and
   store, via the at least one processor, an optimal policy datastructure, in which the optimal policy datastructure is structured to specify a set of parameters that define the structure of the optimal policy.
132. The system of embodiment 131, in which the optimal policy reward function is structured to specify an intermedia year reward function and a final year reward function.
133. The system of embodiment 132, in which the final year reward function is structured to specify a bequest reward function.
134. The system of embodiment 131, in which the user information data fields comprise: user age and user location.
135. The system of embodiment 131, in which the accounts information data fields comprise: account type and account holdings for the set of user accounts.
136. The system of embodiment 131, in which the retirement information data fields comprise: retirement year, planning horizon, and constant periodic withdrawal amount.
137. The system of embodiment 136, in which the retirement information data fields further comprise at least one of: variable periodic withdrawal amount, bequest amount.
138. The system of embodiment 131, in which an initial state further comprises incomes information data fields, and in which the incomes information data fields comprise: periodic income amount and income date range for a set of user incomes.
139. The system of embodiment 131, in which the ML training request datastructure is structured to specify market return simulator settings data fields.
140. The system of embodiment 131, in which the negative-asset-value-force cost for the current planning period is calculated using a set of online API calls.
141. The system of embodiment 131, in which the negative-asset-value-force cost for the current planning period is calculated using a machine learning estimator.
142. The system of embodiment 131, in which the reward value for the current planning period is determined by evaluating the withdrawal policy for the current planning period adjusted by the negative-asset-value-force cost for the current planning period.
143. The system of embodiment 131, in which the instructions to generate the training sample datastructure are further structured as:
   calculate, via the at least one processor, account holdings for the set of user accounts for the next planning period based on a simulated portfolio return for the current planning period; and
   update, via the at least one processor, the current state using the calculated account holdings for the set of user accounts for the next planning period.
144. The system of embodiment 131, in which the RL technique is Proximal Policy Optimization.
145. The system of embodiment 144, in which the set of parameters that define the structure of the optimal policy comprises: network structure and weights for each layer of an actor network.
146. An artificial intelligence-based optimized withdrawal policy recommendation engine generating processor-implemented process, including processing processor-executable instructions via at least one processor from a component collection stored in at least one memory, the component collection storage structured with processor-executable instructions comprising:
   obtain, via the at least one processor, a machine learning (ML) training request datastructure, in which the ML training request datastructure is structured to specify an optimal policy reward function and a set of training sample configuration datastructures, in which a training sample configuration datastructure is structured to specify an initial state comprising user information data fields, accounts information data fields, and retirement information data fields;
   generate, via the at least one processor, a set of training sample datastructures using the optimal policy reward function and a specified training sample configuration datastructure from the set of training sample configuration datastructures, in which the instructions to generate a training sample datastructure are structured as:
      determine, via the at least one processor, a current state associated with the specified training sample configuration datastructure for a current planning period, in which the current state is the initial state associated with the specified training sample configuration datastructure for an initial planning period, and an updated state for subsequent planning periods;
      determine, via the at least one processor, an action for the current planning period using an actor network, in which the action is a withdrawal policy for a set of user accounts, in which the actor network takes the current state as input and outputs the withdrawal policy for the current planning period;
      calculate, via the at least one processor, a negative-asset-value-force cost for the current planning period based on the action for the current planning period;
      determine, via the at least one processor, a reward value for the current planning period using the optimal policy reward function; and
      store, via the at least one processor, the current state, the action for the current planning period, and the reward value as data fields of the training sample datastructure;
   determine, via the at least one processor, an optimal policy using a reinforcement learning (RL) technique and the generated set of training sample datastructures, in which the optimal policy provides optimized withdrawal policy recommendations based on a provided initial state; and
   store, via the at least one processor, an optimal policy datastructure, in which the optimal policy datastructure is structured to specify a set of parameters that define the structure of the optimal policy.
147. The process of embodiment 146, in which the optimal policy reward function is structured to specify an intermedia year reward function and a final year reward function.
148. The process of embodiment 147, in which the final year reward function is structured to specify a bequest reward function.
149. The process of embodiment 146, in which the user information data fields comprise: user age and user location.
150. The process of embodiment 146, in which the accounts information data fields comprise: account type and account holdings for the set of user accounts.
151. The process of embodiment 146, in which the retirement information data fields comprise: retirement year, planning horizon, and constant periodic withdrawal amount.
152. The process of embodiment 151, in which the retirement information data fields further comprise at least one of: variable periodic withdrawal amount, bequest amount.
153. The process of embodiment 146, in which an initial state further comprises incomes information data fields, and in which the incomes information data fields comprise: periodic income amount and income date range for a set of user incomes.
154. The process of embodiment 146, in which the ML training request datastructure is structured to specify market return simulator settings data fields.
155. The process of embodiment 146, in which the negative-asset-value-force cost for the current planning period is calculated using a set of online API calls.
156. The process of embodiment 146, in which the negative-asset-value-force cost for the current planning period is calculated using a machine learning estimator.
157. The process of embodiment 146, in which the reward value for the current planning period is determined by evaluating the withdrawal policy for the current planning period adjusted by the negative-asset-value-force cost for the current planning period.
158. The process of embodiment 146, in which the instructions to generate the training sample datastructure are further structured as:
   calculate, via the at least one processor, account holdings for the set of user accounts for the next planning period based on a simulated portfolio return for the current planning period; and
   update, via the at least one processor, the current state using the calculated account holdings for the set of user accounts for the next planning period.
159. The process of embodiment 146, in which the RL technique is Proximal Policy Optimization.
160. The process of embodiment 159, in which the set of parameters that define the structure of the optimal policy comprises: network structure and weights for each layer of an actor network.

MRLAPM Controller

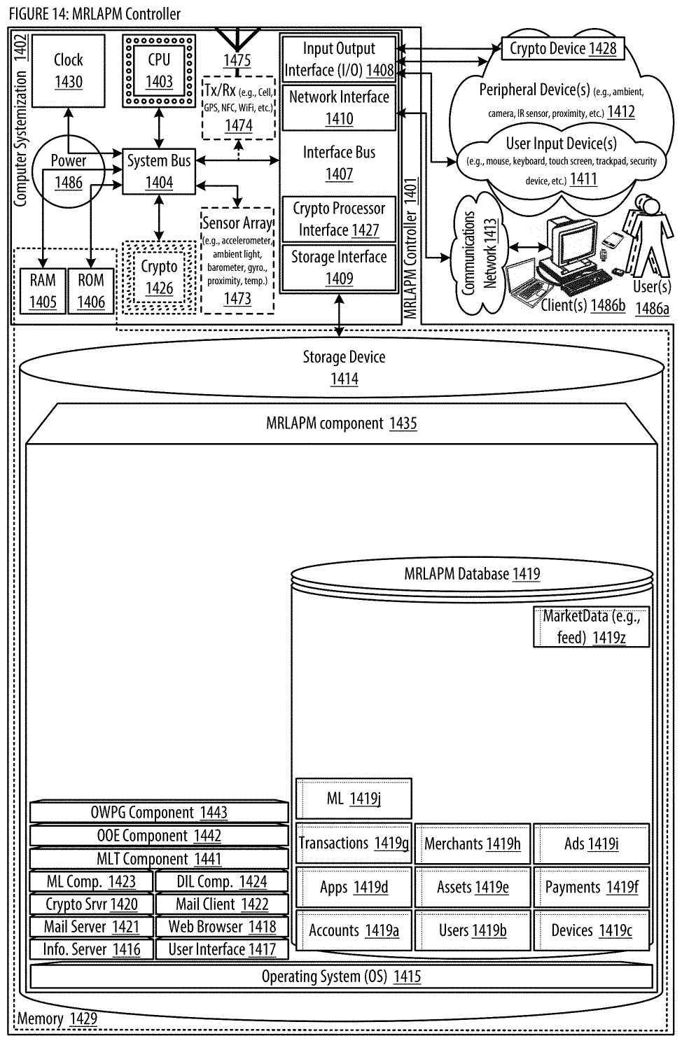

FIG. 14 shows a block diagram illustrating non-limiting, example embodiments of a MRLAPM controller. In this embodiment, the MRLAPM controller 1401 may serve to aggregate, process, store, search, serve, identify, instruct, generate, match, and/or facilitate interactions with a computer through machine learning and database systems technologies, and/or other related data.

Users, which may be people and/or other systems, may engage information technology systems (e.g., computers) to facilitate information processing. In turn, computers employ processors to process information; such processors 1403 may be referred to as central processing units (CPU). One form of processor is referred to as a microprocessor. CPUs use communicative circuits to pass binary encoded signals acting as instructions to allow various operations. These instructions may be operational and/or data instructions containing and/or referencing other instructions and data in various processor accessible and operable areas of memory 1429 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the MRLAPM controller 1401 may be connected to and/or communicate with entities such as, but not limited to: one or more users from peripheral devices 1412 (e.g., user input devices 1411); an optional cryptographic processor device 1428; and/or a communications network 1413.

Networks comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is referred to as a “node.” Networks are generally thought to facilitate the transfer of information from source points to destinations. A node specifically tasked with furthering the passage of information from a source to a destination is called a “router.” There are many forms of networks such as Local Area Networks (LANs), Pico networks, Wide Area Networks (WANs), Wireless Networks (WLANs), etc. For example, the Internet is, generally, an interconnection of a multitude of networks whereby remote clients and servers may access and interoperate with one another.

The MRLAPM controller 1401 may be based on computer systems that may comprise, but are not limited to, components such as: a computer systemization 1402 connected to memory 1429.

Computer Systemization

A computer systemization 1402 may comprise a clock 1430, central processing unit (“CPU(s)” and/or “processor(s)” (these terms are used interchangeably throughout the disclosure unless noted to the contrary)) 1403, a memory 1429 (e.g., a read only memory (ROM) 1406, a random access memory (RAM) 1405, etc.), and/or an interface bus 1407, and most frequently, although not necessarily, are all interconnected and/or communicating through a system bus 1404 on one or more (mother)board(s) 1402 having conductive and/or otherwise transportive circuit pathways through which instructions (e.g., binary encoded signals) may travel to effectuate communications, operations, storage, etc. The computer systemization may be connected to a power source 1486; e.g., optionally the power source may be internal. Optionally, a cryptographic processor 1426 may be connected to the system bus. In another embodiment, the cryptographic processor, transceivers (e.g., ICs) 1474, and/or sensor array (e.g., accelerometer, altimeter, ambient light, barometer, global positioning system (GPS) (thereby allowing MRLAPM controller to determine its location), gyroscope, magnetometer, pedometer, proximity, ultra-violet sensor, etc.) 1473 may be connected as either internal and/or external peripheral devices 1412 via the interface bus I/O 1408 (not pictured) and/or directly via the interface bus 1407. In turn, the transceivers may be connected to antenna(s) 1475, thereby effectuating wireless transmission and reception of various communication and/or sensor protocols; for example the antenna(s) may connect to various transceiver chipsets (depending on deployment needs), including: Broadcom® BCM4329FKUBG transceiver chip (e.g., providing 802.11n, Bluetooth 2.1+EDR, FM, etc.); a Broadcom® BCM4752 GPS receiver with accelerometer, altimeter, GPS, gyroscope, magnetometer; a Broadcom® BCM4335 transceiver chip (e.g., providing 2G, 3G, and 4G long-term evolution (LTE) cellular communications; 802.11ac, Bluetooth 4.0 low energy (LE) (e.g., beacon features)); a Broadcom® BCM43341 transceiver chip (e.g., providing 2G, 3G and 4G LTE cellular communications; 802.11g/, Bluetooth 4.0, near field communication (NFC), FM radio); an Infineon Technologies® X-Gold 618-PMB9800 transceiver chip (e.g., providing 2G/3G HSDPA/HSUPA communications); a MediaTek® MT6620 transceiver chip (e.g., providing 802.11a/ac/b/g/n (also known as WiFi in numerous iterations), Bluetooth 4.0 LE, FM, GPS; a Lapis Semiconductor® ML8511 UV sensor; a maxim integrated MAX44000 ambient light and infrared proximity sensor; a Texas Instruments® WiLink WL1283 transceiver chip (e.g., providing 802.11n, Bluetooth 3.0, FM, GPS); and/or the like. The system clock may have a crystal oscillator and generates a base signal through the computer systemization's circuit pathways. The clock may be coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU is often packaged in a number of formats varying from large supercomputer(s) and mainframe(s) computers, down to mini computers, servers, desktop computers, laptops, thin clients (e.g., Chromebooks®), netbooks, tablets (e.g., Android®, iPads®, and Windows® tablets, etc.), mobile smartphones (e.g., Android®, iPhones®, Nokia®, Palm® and Windows® phones, etc.), wearable device(s) (e.g., headsets (e.g., Apple AirPods (Pro)®, glasses, goggles (e.g., Google Glass®), watches, etc.), and/or the like. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1429 beyond the processor itself; internal memory may include, but is not limited to: fast registers, various levels of cache memory (e.g., level 1, 2, 3, etc.), (dynamic/static) RAM, solid state memory, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon®, Duron® and/or Opteron®; Apple's® A series of processors (e.g., A5, A6, A7, A8, etc.); ARM's® application, embedded and secure processors; IBM® and/or Motorola's DragonBall® and PowerPC®; IBM's® and Sony's® Cell processor; Intel's® 80X86 series (e.g., 80386, 80486), Pentium®, Celeron®, Core (2) Duo®, i series (e.g., i3, i5, i7, i9, etc.), Itanium®, Xeon®, and/or XScale®; Motorola's® 680X0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code), e.g., via load/read address commands; e.g., the CPU may read processor issuable instructions from memory (e.g., reading it from a component collection (e.g., an interpreted and/or compiled program application/library including allowing the processor to execute instructions from the application/library) stored in the memory). Such instruction passing facilitates communication within the MRLAPM controller and beyond through various interfaces. Should processing requirements dictate a greater amount speed and/or capacity, distributed processors (e.g., see Distributed MRLAPM below), mainframe, multi-core, parallel, and/or super-computer architectures may similarly be employed. Alternatively, should deployment requirements dictate greater portability, smaller mobile devices (e.g., Personal Digital Assistants (PDAs)) may be employed.

Depending on the particular implementation, features of the MRLAPM may be achieved by implementing a microcontroller such as CAST's® R8051XC2 microcontroller; Diligent's® Basys 3 Artix-7, Nexys A7-100T, U192015125IT, etc.; Intel's® MCS 51 (i.e., 8051 microcontroller); and/or the like. Also, to implement certain features of the MRLAPM, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the MRLAPM component collection (distributed or otherwise) and/or features may be implemented via the microprocessor and/or via embedded components; e.g., via ASIC, coprocessor, DSP, FPGA, and/or the like. Alternately, some implementations of the MRLAPM may be implemented with embedded components that are configured and used to achieve a variety of features or signal processing.

Depending on the particular implementation, the embedded components may include software solutions, hardware solutions, and/or some combination of both hardware/software solutions. For example, MRLAPM features discussed herein may be achieved through implementing FPGAs, which are a semiconductor devices containing programmable logic components called “logic blocks”, and programmable interconnects, such as the high performance FPGA Virtex® series and/or the low cost Spartan® series manufactured by Xilinx®. Logic blocks and interconnects can be programmed by the customer or designer, after the FPGA is manufactured, to implement any of the MRLAPM features. A hierarchy of programmable interconnects allow logic blocks to be interconnected as needed by the MRLAPM system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the MRLAPM may be developed on FPGAs and then migrated into a fixed version that more resembles ASIC implementations. Alternate or coordinating implementations may migrate MRLAPM controller features to a final ASIC instead of or in addition to FPGAs. Depending on the implementation all of the aforementioned embedded components and microprocessors may be considered the “CPU” and/or “processor” for the MRLAPM.

Power Source

The power source 1486 may be of any various form for powering small electronic circuit board devices such as the following power cells alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1486 is connected to at least one of the interconnected subsequent components of the MRLAPM thereby providing an electric current to all subsequent components. In one example, the power source 1486 is connected to the system bus component 1404. In an alternative embodiment, an outside power source 1486 is provided through a connection across the I/O 1408 interface. For example, Ethernet (with power on Ethernet), IEEE 1394, USB and/or the like connections carry both data and power across the connection and is therefore a suitable source of power.

Interface Adapters

Interface bus(ses) 1407 may accept, connect, and/or communicate to a number of interface adapters, variously although not necessarily in the form of adapter cards, such as but not limited to: input output interfaces (I/O) 1408, storage interfaces 1409, network interfaces 1410, and/or the like. Optionally, cryptographic processor interfaces 1427 similarly may be connected to the interface bus. The interface bus provides for the communications of interface adapters with one another as well as with other components of the computer systemization. Interface adapters are adapted for a compatible interface bus. Interface adapters variously connect to the interface bus via a slot architecture. Various slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1409 may accept, communicate, and/or connect to a number of storage devices such as, but not limited to: (removable) storage devices 1414, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Non-Volatile Memory (NVM) Express (NVMe), Small Computer Systems Interface (SCSI), Thunderbolt, Universal Serial Bus (USB), and/or the like.

Network interfaces 1410 may accept, communicate, and/or connect to a communications network 1413. Through a communications network 1413, the MRLAPM controller is accessible through remote clients 1433b (e.g., computers with web browsers) by users 1433a. Network interfaces may employ connection protocols such as, but not limited to: direct connect, Ethernet (thick, thin, twisted pair 10/100/1000/10000 Base T, and/or the like), Token Ring, wireless connection such as IEEE 802.11a-x, and/or the like. Should processing requirements dictate a greater amount speed and/or capacity, distributed network controllers (e.g., see Distributed MRLAPM below), architectures may similarly be employed to pool, load balance, and/or otherwise decrease/increase the communicative bandwidth required by the MRLAPM controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi, Wireless Application Protocol (WAP), I-mode, and/or the like); and/or the like. A network interface may be regarded as a specialized form of an input output interface. Further, multiple network interfaces 1410 may be used to engage with various communications network types 1413. For example, multiple network interfaces may be employed to allow for the communication over broadcast, multicast, and/or unicast networks.

Input Output interfaces (I/O) 1408 may accept, communicate, and/or connect to user, peripheral devices 1412 (e.g., input devices 1411), cryptographic processor devices 1428, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, Thunderbolt/USB-C, VGA, and/or the like; wireless transceivers: 802.11a/ac/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One output device may include a video display, which may comprise a Cathode Ray Tube (CRT), Liquid Crystal Display (LCD), Light-Emitting Diode (LED), Organic Light-Emitting Diode (OLED), and/or the like based monitor with an interface (e.g., HDMI circuitry and cable) that accepts signals from a video interface, may be used. The video interface composites information generated by a computer systemization and generates video signals based on the composited information in a video memory frame. Another output device is a television set, which accepts signals from a video interface. The video interface provides the composited video information through a video connection interface that accepts a video display interface (e.g., an RCA composite video connector accepting an RCA composite video cable; a DVI connector accepting a DVI display cable, etc.).

Peripheral devices 1412 may be connected and/or communicate to I/O and/or other facilities of the like such as network interfaces, storage interfaces, directly to the interface bus, system bus, the CPU, and/or the like. Peripheral devices may be external, internal and/or part of the MRLAPM controller. Peripheral devices may include: antenna, audio devices (e.g., line-in, line-out, microphone input, speakers, etc.), cameras (e.g., gesture (e.g., Microsoft Kinect) detection, motion detection, still, video, webcam, etc.), dongles (e.g., for copy protection ensuring secure transactions with a digital signature, as connection/format adaptors, and/or the like), external processors (for added capabilities; e.g., crypto devices 528), force-feedback devices (e.g., vibrating motors), infrared (IR) transceiver, network interfaces, printers, scanners, sensors/sensor arrays and peripheral extensions (e.g., ambient light, GPS, gyroscopes, proximity, temperature, etc.), storage devices, transceivers (e.g., cellular, GPS, etc.), video devices (e.g., goggles, monitors, etc.), video sources, visors, and/or the like. Peripheral devices often include types of input devices (e.g., cameras).

User input devices 1411 often are a type of peripheral device 512 (see above) and may include: accelerometers, cameras, card readers, dongles, finger print readers, gloves, graphics tablets, joysticks, keyboards, microphones, mouse (mice), remote controls, security/biometric devices (e.g., facial identifiers, fingerprint reader, iris reader, retina reader, etc.), styluses, touch screens (e.g., capacitive, resistive, etc.), trackballs, trackpads, watches, and/or the like.

It should be noted that although user input devices and peripheral devices may be employed, the MRLAPM controller may be embodied as an embedded, dedicated, and/or monitor-less (i.e., headless) device, and access may be provided over a network interface connection.

Cryptographic units such as, but not limited to, microcontrollers, processors 1426, interfaces 1427, and/or devices 1428 may be attached, and/or communicate with the MRLAPM controller. A MC68HC16 microcontroller, manufactured by Motorola, Inc.®, may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other specialized cryptographic processors include: Broadcom's® CryptoNetX and other Security Processors; nCipher's® nShield; SafeNet's® Luna PCI (e.g., 7100) series; Semaphore Communications'® 40 MHz Roadrunner 184; Sun's® Cryptographic Accelerators (e.g., Accelerator 6000 PCIe Board, Accelerator 500 Daughtercard); Via Nano® Processor (e.g., L2100, L2200, U2400) line, which is capable of performing 500+MB/s of cryptographic instructions; VLSI Technology's® 33 MHz 6868; and/or the like.

Memory

Generally, any mechanization and/or embodiment allowing a processor to affect the storage and/or retrieval of information is regarded as memory 1429. The storing of information in memory may result in a physical alteration of the memory to have a different physical state that makes the memory a structure with a unique encoding of the memory stored therein. Often, memory is a fungible technology and resource, thus, any number of memory embodiments may be employed in lieu of or in concert with one another. It is to be understood that the MRLAPM controller and/or a computer systemization may employ various forms of memory 1429. For example, a computer systemization may be configured to have the operation of on-chip CPU memory (e.g., registers), RAM, ROM, and any other storage devices performed by a paper punch tape or paper punch card mechanism; however, such an embodiment would result in an extremely slow rate of operation. In one configuration, memory 1429 will include ROM 1406, RAM 1405, and a storage device 1414. A storage device 1414 may be any various computer system storage. Storage devices may include: an array of devices (e.g., Redundant Array of Independent Disks (RAID)); a cache memory, a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); RAM drives; register memory (e.g., in a CPU), solid state memory devices (USB memory, solid state drives (SSD), etc.); other processor-readable storage mediums; and/or other devices of the like. Thus, a computer systemization generally employs and makes use of memory.

Component Collection

The memory 1429 may contain a collection of processor-executable application/library/program and/or database components (e.g., including processor-executable instructions) and/or data such as, but not limited to: operating system component(s) 1415 (operating system); information server component(s) 1416 (information server); user interface component(s) 1417 (user interface); Web browser component(s) 1418 (Web browser); database(s) 1419; mail server component(s) 1421; mail client component(s) 1422; cryptographic server component(s) 1420 (cryptographic server); machine learning component 1423; distributed immutable ledger component 1424; the MRLAPM component(s) 1435 (e.g., which may include MLT, OOE, OWPG 1441-1443, and/or the like components); and/or the like (i.e., collectively referred to throughout as a “component collection”). These components may be stored and accessed from the storage devices and/or from storage devices accessible through an interface bus. Although unconventional program components such as those in the component collection may be stored in a local storage device 1414, they may also be loaded and/or stored in memory such as: cache, peripheral devices, processor registers, RAM, remote storage facilities through a communications network, ROM, various forms of memory, and/or the like.

Operating System

The operating system component 1415 is an executable program component facilitating the operation of the MRLAPM controller. The operating system may facilitate access of I/O, network interfaces, peripheral devices, storage devices, and/or the like. The operating system may be a highly fault tolerant, scalable, and secure system such as: Apple's Macintosh OS X (Server) and macOS®; AT&T Plan 9®; Be OS®; Blackberry's QNX®; Google's Chrome®; Microsoft's Windows® 7/8/10; Unix and Unix-like system distributions (such as AT&T's UNIX®; Berkley Software Distribution (BSD)® variations such as FreeBSD®, NetBSD, OpenBSD, and/or the like; Linux distributions such as Red Hat, Ubuntu, and/or the like); and/or the like operating systems. However, more limited and/or less secure operating systems also may be employed such as Apple Macintosh OS® (i.e., versions 1-9), IBM OS/2®, Microsoft DOS®, Microsoft Windows 2000/2003/3.1/95/98/CE/Millennium/Mobile/NT/Vista/XP/7/X (Server)®, Palm OS®, and/or the like. Additionally, for robust mobile deployment applications, mobile operating systems may be used, such as: Apple's iOS®; China Operating System COS®; Google's Android®; Microsoft Windows RT/Phone®; Palm's WebOS®; Samsung/Intel's Tizen®; and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may facilitate the interaction with communications networks, data, I/O, peripheral devices, program components, memory, user input devices, and/or the like. The operating system may provide communications protocols that allow the MRLAPM controller to communicate with other entities through a communications network 1413. Various communication protocols may be used by the MRLAPM controller as a subcarrier transport mechanism for interaction, such as, but not limited to: multicast, TCP/IP, UDP, unicast, and/or the like.

Information Server

An information server component 1416 is a stored program component that is executed by a CPU. The information server may be an Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C # and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, Ruby, wireless application protocol (WAP), WebObjects®, and/or the like. The information server may support secure communications protocols such as, but not limited to, File Transfer Protocol (FTP(S)); HyperText Transfer Protocol (HTTP); Secure Hypertext Transfer Protocol (HTTPS), Secure Socket Layer (SSL) Transport Layer Security (TLS), messaging protocols (e.g., America Online (AOL) Instant Messenger (AIM)®, Application Exchange (APEX), ICQ, Internet Relay Chat (IRC), Microsoft Network (MSN) Messenger® Service, Presence and Instant Messaging Protocol (PRIM), Internet Engineering Task Force's® (IETF's) Session Initiation Protocol (SIP), SIP for Instant Messaging and Presence Leveraging Extensions (SIMPLE), Slack®, open XML-based Extensible Messaging and Presence Protocol (XMPP) (i.e., Jabber® or Open Mobile Alliance's (OMA's) Instant Messaging and Presence Service (IMPS)), Yahoo! Instant Messenger® Service, and/or the like). The information server may provide results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the MRLAPM controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the MRLAPM database 1419, operating systems, other program components, user interfaces, Web browsers, and/or the like.

Access to the MRLAPM database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the MRLAPM. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in SQL by instantiating a search string with the proper join/select commands based on the tagged text entries, and the resulting command is provided over the bridge mechanism to the MRLAPM as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as buttons, check boxes, cursors, graphical views, menus, scrollers, text fields, and windows (collectively referred to as widgets) similarly facilitate the access, capabilities, operation, and display of data and computer hardware and operating system resources, and status. Operation interfaces are called user interfaces. Graphical user interfaces (GUIs) such as the Apple's iOS®, Macintosh Operating System's Aqua®; IBM's OS/2®; Google's Chrome® (e.g., and other webbrowser/cloud based client OSs); Microsoft's Windows® 2000/2003/3.1/95/98/CE/Millennium/Mobile/NT/Vista/XP/7/X (Server)® (i.e., Aero, Surface, etc.); Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface®, and/or the like, any of which may be used and) provide a baseline and mechanism of accessing and displaying information graphically to users.

A user interface component 1417 is a stored program component that is executed by a CPU. The user interface may be a graphic user interface as provided by, with, and/or atop operating systems and/or operating environments, and may provide executable library APIs (as may operating systems and the numerous other components noted in the component collection) that allow instruction calls to generate user interface elements such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 1418 is a stored program component that is executed by a CPU. The Web browser may be a hypertext viewing application such as Apple's (mobile) Safari®, Google's Chrome®, Microsoft Internet Explorer®, Mozilla's Firefox®, Netscape Navigator®, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox®, Safari® Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the MRLAPM enabled nodes. The combined application may be nugatory on systems employing Web browsers.

Mail Server

A mail server component 1421 is a stored program component that is executed by a CPU 1403. The mail server may be an Internet mail server such as, but not limited to: dovecot, Courier IMAP, Cyrus IMAP, Maildir, Microsoft Exchange, sendmail, and/or the like. The mail server may allow for the execution of program components through facilities such as ASP, ActiveX, (ANSI) (Objective-) C (++), C # and/or .NET, CGI scripts, Java, JavaScript, PERL, PHP, pipes, Python, WebObjects®, and/or the like. The mail server may support communications protocols such as, but not limited to: Internet message access protocol (IMAP), Messaging Application Programming Interface (MAPI)/Microsoft Exchange, post office protocol (POPS), simple mail transfer protocol (SMTP), and/or the like. The mail server can route, forward, and process incoming and outgoing mail messages that have been sent, relayed and/or otherwise traversing through and/or to the MRLAPM. Alternatively, the mail server component may be distributed out to mail service providing entities such as Google's® cloud services (e.g., Gmail and notifications may alternatively be provided via messenger services such as AOL's Instant Messenger®, Apple's iMessage®, Google Messenger®, SnapChat®, etc.).

Access to the MRLAPM mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 1422 is a stored program component that is executed by a CPU 1403. The mail client may be a mail viewing application such as Apple Mail®, Microsoft Entourage®, Microsoft Outlook®, Microsoft Outlook Express®, Mozilla®, Thunderbird®, and/or the like. Mail clients may support a number of transfer protocols, such as: IMAP, Microsoft Exchange, POPS, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 1420 is a stored program component that is executed by a CPU 1403, cryptographic processor 1426, cryptographic processor interface 1427, cryptographic processor device 1428, and/or the like. Cryptographic processor interfaces will allow for expedition of encryption and/or decryption requests by the cryptographic component; however, the cryptographic component, alternatively, may run on a CPU and/or GPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component facilitates numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), Transport Layer Security (TLS), and/or the like. Employing such encryption security protocols, the MRLAPM may encrypt all incoming and/or outgoing communications and may serve as node within a virtual private network (VPN) with a wider communications network. The cryptographic component facilitates the process of “security authorization” whereby access to a resource is inhibited by a security protocol and the cryptographic component effects authorized access to the secured resource. In addition, the cryptographic component may provide unique identifiers of content, e.g., employing an MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to allow the MRLAPM component to engage in secure transactions if so desired. The cryptographic component facilitates the secure accessing of resources on the MRLAPM and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

Machine Learning (ML)

In one non limiting embodiment, the MRLAPM includes a machine learning component 1423, which may be a stored program component that is executed by a CPU 1403. The machine learning component, alternatively, may run on a set of specialized processors, ASICs, FPGAs, GPUs, and/or the like. The machine learning component may be deployed to execute serially, in parallel, distributed, and/or the like, such as by utilizing cloud computing. The machine learning component may employ an ML platform such as Amazon SageMaker, Azure Machine Learning, DataRobot AI Cloud, Google AI Platform, IBM Watson® Studio, and/or the like. The machine learning component may be implemented using an ML framework such as PyTorch, Apache MXNet, MathWorks Deep Learning Toolbox, scikit-learn, TensorFlow, XGBoost, and/or the like. The machine learning component facilitates training and/or testing of ML prediction logic data structures (e.g., models) and/or utilizing ML prediction logic data structures (e.g., models) to output ML predictions by the MRLAPM. The machine learning component may employ various artificial intelligence and/or learning mechanisms such as Reinforcement Learning, Supervised Learning, Unsupervised Learning, and/or the like. The machine learning component may employ ML prediction logic data structure (e.g., model) types such as Bayesian Networks, Classification prediction logic data structures (e.g., models), Decision Trees, Neural Networks (NNs), Regression prediction logic data structures (e.g., models), and/or the like.

Distributed Immutable Ledger (DIL)

In one non limiting embodiment, the MRLAPM includes a distributed immutable ledger component 1424, which may be a stored program component that is executed by a CPU 1403. The distributed immutable ledger component, alternatively, may run on a set of specialized processors, ASICs, FPGAs, GPUs, and/or the like. The distributed immutable ledger component may be deployed to execute serially, in parallel, distributed, and/or the like, such as by utilizing a peer-to-peer network. The distributed immutable ledger component may be implemented as a blockchain (e.g., public blockchain, private blockchain, hybrid blockchain) that comprises cryptographically linked records (e.g., blocks). The distributed immutable ledger component may employ a platform such as Bitcoin, Bitcoin Cash, Dogecoin, Ethereum, Litecoin, Monero, Zcash, and/or the like. The distributed immutable ledger component may employ a consensus mechanism such as proof of authority, proof of space, proof of steak, proof of work, and/or the like. The distributed immutable ledger component may be used to provide functionality such as data storage, cryptocurrency, inventory tracking, non-fungible tokens (NFTs), smart contracts, and/or the like.

The MRLAPM Database

The MRLAPM database component 1419 may be embodied in a database and its stored data. The database is a stored program component, which is executed by the CPU; the stored program component portion configuring the CPU to process the stored data. The database may be a fault tolerant, relational, scalable, secure database such as Claris FileMaker®, MySQL®, Oracle®, Sybase®, etc. may be used. Additionally, optimized fast memory and distributed databases such as IBM's Netezza®, MongoDB's MongoDB®, opensource Hadoop®, opensource VoltDB, SAP's Hana®, etc. Relational databases are an extension of a flat file. Relational databases include a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. Alternative key fields may be used from any of the fields having unique value sets, and in some alternatives, even non-unique values in combinations with other fields. More precisely, they uniquely identify rows of a table on the “one” side of a one-to-many relationship.

Alternatively, the MRLAPM database may be implemented using various other data-structures, such as an array, hash, (linked) list, struct, structured text file (e.g., XML), table, flat file database, and/or the like. Such data-structures may be stored in memory and/or in (structured) files. In another alternative, an object-oriented database may be used, such as Frontier™, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the MRLAPM database is implemented as a data-structure, the use of the MRLAPM database 1419 may be integrated into another component such as the MRLAPM component 1435. Also, the database may be implemented as a mix of data structures, objects, programs, relational structures, scripts, and/or the like. Databases may be consolidated and/or distributed in countless variations (e.g., see Distributed MRLAPM below). Portions of databases, e.g., tables, may be exported and/or imported and thus decentralized and/or integrated.

In another embodiment, the database component (and/or other storage mechanism of the MRLAPM) may store data immutably so that tampering with the data becomes physically impossible and the fidelity and security of the data may be assured. In some embodiments, the database may be stored to write only or write once, read many (WORM) mediums. In another embodiment, the data may be stored on distributed ledger systems (e.g., via blockchain) so that any tampering to entries would be readily identifiable. In one embodiment, the database component may employ the distributed immutable ledger component DIL 1424 mechanism.

In one embodiment, the database component 1419 includes several tables representative of the schema, tables, structures, keys, entities and relationships of the described database 1419a-z:

An accounts table 1419a includes fields such as, but not limited to: an accountID, accountOwnerID, accountContactID, assetIDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, accountNumber, routingNumber, linkWalletsID, accountPrioritAccaountRatio, accountAddress, accountState, accountZIPcode, accountCountry, accountEmail, accountPhone, accountAuthKey, accountIPaddress, accountURLAccessCode, accountPortNo, accountAuthorizationCode, accountAcces sPrivileges, accountPreferences, accountRestrictions, and/or the like;

A users table 1419b includes fields such as, but not limited to: a userID, userSSN, taxID, userContactID, accountID, assetIDs, deviceIDs, paymentIDs, transactionIDs, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocialAccountID, contactType, contactRelationship, userPhone, userAddress, userCity, userState, userZIPCode, userCountry, userAuthorizationCode, userAccessPrivilges, userPreferences, userRestrictions, and/or the like (the user table may support and/or track multiple entity accounts on a MRLAPM);

An devices table 1419c includes fields such as, but not limited to: deviceID, sensorIDs, accountID, assetIDs, paymentIDs, deviceType, deviceName, deviceManufacturer, deviceModel, deviceVersion, deviceSerialNo, deviceIPaddress, deviceMACaddress, device_ECID, deviceUUID, deviceLocation, deviceCertificate, deviceOS, appIDs, deviceResources, deviceSession, authKey, deviceSecureKey, walletAppInstalledFlag, deviceAccessPrivileges, devicePreferences, deviceRestrictions, hardware_config, software_config, storage_location, sensor_value, pin_reading, data_length, channel_requirement, sensor_name, sensor_model_no, sensor_manufacturer, sensor_type, sensor_serial_number, sensor_power_requirement, device_power_requirement, location, sensor_associated_tool, sensor_dimensions, device_dimensions, sensor_communications_type, device_communications_type, power_percentage, power_condition, temperature_setting, speed_adjust, hold_duration, part_actuation, and/or the like. Device table may, in some embodiments, include fields corresponding to one or more Bluetooth profiles, such as those published at https://www.bluetooth.org/en-us/specification/adopted-specifications, and/or other device specifications, and/or the like;

An apps table 1419d includes fields such as, but not limited to: appID, appName, appType, appDependencies, accountID, deviceIDs, transactionID, userID, appStoreAuthKey, appStoreAccountID, appStoreIPaddress, appStoreURLaccessCode, appStorePortNo, appAccessPrivileges, appPreferences, app Restrictions, portNum, access_API_call, linked_wallets_list, and/or the like;

An assets table 1419e includes fields such as, but not limited to: assetID, accountID, userID, distributorAccountID, distributorPaymentID, distributorOnwerID, assetOwnerID, assetType, as setSourceDeviceID, as setSourceDeviceType, as setSourceDeviceName, assetSourceDistributionChannelID, assetSourceDistributionChannelType, assetSourceDistributionChannelName, assetTargetChannelID, assetTargetChannelType, assetTargetChannelName, as setName, assetSeriesName, assetSeriesSeason, assetSeriesEpisode, assetCode, assetQuantity, assetCost, assetPrice, assetValue, assetManufactuer, assetModelNo, assetSerialNo, assetLocation, assetAddress, assetState, assetZlPcode, assetState, assetCountry, assetEmail, assetlPaddress, assetURLaccessCode, assetOwnerAccountID, subscriptionIDs, as setAuthroizationCode, assetAccessPrivileges, assetPreferences, assetRestrictions, assetAPI, assetAPIconnectionAddress, and/or the like;

A payments table 1419f includes fields such as, but not limited to: paymentID, accountID, userID, couponID, couponValue, couponConditions, couponExpiration, paymentType, paymentAccountNo, paymentAccountName, paymentAccountAuthorizationCodes, paymentExpirationDate, paymentCCV, paymentRoutingNo, paymentRoutingType, paymentAddress, paymentState, paymentZIPcode, paymentCountry, paymentEmail, paymentAuthKey, paymentIPaddress, paymentURLaccessCode, paymentPortNo, paymentAccessPrivileges, paymentPreferences, payementRestrictions, and/or the like;

An transactions table 1419g includes fields such as, but not limited to: transactionID, accountID, assetIDs, deviceIDs, paymentIDs, transactionIDs, userID, merchantID, transactionType, transactionDate, transactionTime, transactionAmount, transactionQuantity, transactionDetails, productsList, productType, productTitle, productsSummary, productParamsList, transactionNo, transactionAccessPrivileges, transactionPreferences, transactionRestrictions, merchantAuthKey, merchantAuthCode, and/or the like;

An merchants table 1419h includes fields such as, but not limited to: merchantID, merchantTaxID, merchanteName, merchantContactUserID, accountID, issuerID, acquirerID, merchantEmail, merchantAddress, merchantState, merchantZIPcode, merchantCountry, merchantAuthKey, merchantIPaddress, portNum, merchantURLaccessC ode, merchantPortNo, merchantAccessPrivileges, merchantPreferences, merchantRestrictions, and/or the like;

An ads table 1419i includes fields such as, but not limited to: adID, advertiserID, adMerchantID, adNetworkID, adName, adTags, advertiserName, adSponsor, adTime, adGeo, adAttributes, adFormat, adProduct, adText, adMedia, adMediaID, adChannelID, adTagTime, adAudioSignature, adHash, adTemplateID, adTemplateData, adSourceID, adSourceName, adSourceServerlP, adSourceURL, adSourceSecurityProtocol, adSourceFTP, adAuthKey, adAccessPrivileges, adPreferences, adRestrictions, adNetworkXchangeID, adNe tworkXchangeName, adNetworkXchangeCost, adNetworkXchangeMetricType (e.g., CPA, CPC, CPM, CTR, etc.), adNetworkXchangeMetricValue, adNetworkXchangeServer, adNetworkXchangePortNumber, publisherID, publisherAddress, publisherURL, publisherTag, publisherIndustry, publisherName, publisherDescription, siteDomain, siteURL, siteContent, siteTag, siteContext, sitelmpression, siteVisits, siteHeadline, sitePage, siteAdPrice, sitePlacement, sitePosition, bidID, bidExchange, bidOS, bidTarget, bidTimestamp, bidPrice, bidlmpressionID, bidType, bidScore, adType (e.g., mobile, desktop, wearable, largescreen, interstitial, etc.), assetID, merchantID, deviceID, userID, accountID, impressionID, impressionOS, impressionTimeStamp, impressionGeo, impressionAction, impressionType, impressionPublisherID, impressionPublisherURL, and/or the like;

An ML table 1419j includes fields such as, but not limited to: MLID, predictionLogicStructureID, predictionLogicStructureType, predictionLogicStructureConfiguration, predictionLogicStructureTrainedStructure, predictionLogicStructureTrainingData, predictionLogicStructureTrainingDataConfiguration, predictionLogicStructureTestingData, predictionLogicStructureTestingDataConfiguration, predictionLogicStructureOutputData, predictionLogicStructureOutputDataConfiguration, and/or the like;

A market_data table 1419z includes fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe®, Consolidated Quote System® (CQS), Consolidated Tape Association® (CTA), Consolidated Tape System® (CTS), Dun & Bradstreet®, OTC Montage Data Feed® (OMDF), Reuter's Tib®, Triarch®, US equity trade and quote market data®, Unlisted Trading Privileges® (UTP) Trade Data Feed® (UTDF), UTP Quotation Data Feed® (UQDF), and/or the like feeds, e.g., via ITC 2.1 and/or respective feed protocols), for example, through Microsoft's® Active Template Library and Dealing Object Technology's real-time toolkit Rtt.Multi.

In one embodiment, the MRLAPM database may interact with other database systems. For example, employing a distributed database system, queries and data access by search MRLAPM component may treat the combination of the MRLAPM database, an integrated data security layer database as a single database entity (e.g., see Distributed MRLAPM below).

In one embodiment, user programs may contain various user interface primitives, which may serve to update the MRLAPM. Also, various accounts may require custom database tables depending upon the environments and the types of clients the MRLAPM may need to serve. It should be noted that any unique fields may be designated as a key field throughout. In an alternative embodiment, these tables have been decentralized into their own databases and their respective database controllers (i.e., individual database controllers for each of the above tables). The MRLAPM may also be configured to distribute the databases over several computer systemizations and/or storage devices Similarly, configurations of the decentralized database controllers may be varied by consolidating and/or distributing the various database components 1419a-z. The MRLAPM may be configured to keep track of various settings, inputs, and parameters via database controllers.

The MRLAPM database may communicate to and/or with other components in a component collection, including itself, and/or facilities of the like. Most frequently, the MRLAPM database communicates with the MRLAPM component, other program components, and/or the like. The database may contain, retain, and provide information regarding other nodes and data.

The MRLAPMs

The MRLAPM component 1435 is a stored program component that is executed by a CPU via stored instruction code configured to engage signals across conductive pathways of the CPU and ISICI controller components. In one embodiment, the MRLAPM component incorporates any and/or all combinations of the aspects of the MRLAPM that were discussed in the previous figures. As such, the MRLAPM affects accessing, obtaining and the provision of information, services, transactions, and/or the like across various communications networks. The features and embodiments of the MRLAPM discussed herein increase network efficiency by reducing data transfer requirements with the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the MRLAPM's features and facilities, and in many cases reduce the costs, energy consumption/requirements, and extend the life of MRLAPM's underlying infrastructure; this has the added benefit of making the MRLAPM more reliable. Similarly, many of the features and mechanisms are designed to be easier for users to use and access, thereby broadening the audience that may enjoy/employ and exploit the feature sets of the MRLAPM; such ease of use also helps to increase the reliability of the MRLAPM. In addition, the feature sets include heightened security as noted via the Cryptographic components 1420, 1426, 1428 and throughout, making access to the features and data more reliable and secure

The MRLAPM transforms machine learning training input, order optimization input, withdrawal policy optimization input datastructure/inputs, via MRLAPM components (e.g., MLT, OOE, OWPG), into machine learning training output, order optimization output, withdrawal policy optimization output outputs.

The MRLAPM component facilitates access of information between nodes may be developed by employing various development tools and languages such as, but not limited to: Apache® components, Assembly, ActiveX, binary executables, (ANSI) (Objective-) C (++), C # and/or .NET, database adapters, CGI scripts, Java, JavaScript, mapping tools, procedural and object oriented development tools, PERL, PHP, Python, Ruby, shell scripts, SQL commands, web application server extensions, web development environments and libraries (e.g., Microsoft's® ActiveX; Adobe® AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo!® User Interface; and/or the like), WebObjects®, and/or the like. In one embodiment, the MRLAPM server employs a cryptographic server to encrypt and decrypt communications. The MRLAPM component may communicate to and/or with other components in a component collection, including itself, and/or facilities of the like. Most frequently, the MRLAPM component communicates with the MRLAPM database, operating systems, other program components, and/or the like. The MRLAPM may contain, communicate, generate, obtain, and/or provide program component, system, user, and/or data communications, requests, and/or responses.

Distributed MRLAPMs

The structure and/or operation of any of the MRLAPM node controller components may be combined, consolidated, and/or distributed in any number of ways to facilitate development and/or deployment Similarly, the component collection may be combined in any number of ways to facilitate deployment and/or development. To accomplish this, one may integrate the components into a common code base or in a facility that can dynamically load the components on demand in an integrated fashion. As such, a combination of hardware may be distributed within a location, within a region and/or globally where logical access to a controller may be abstracted as a singular node, yet where a multitude of private, semiprivate and publicly accessible node controllers (e.g., via dispersed data centers) are coordinated to serve requests (e.g., providing private cloud, semi-private cloud, and public cloud computing resources) and allowing for the serving of such requests in discrete regions (e.g., isolated, local, regional, national, global cloud access, etc.).

The component collection may be consolidated and/or distributed in countless variations through various data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so as discussed through the disclosure and/or through various other data processing communication techniques.

The configuration of the MRLAPM controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like. For example, cloud services such as Amazon Data Services®, Microsoft Azure®, Hewlett Packard Helion®, IBM® Cloud services allow for MRLAPM controller and/or MRLAPM component collections to be hosted in full or partially for varying degrees of scale.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), NeXT Computer, Inc.'s (Dynamic) Object Linking, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar A grammar may be developed by using development tools such as JSON, lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the MRLAPM controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via an SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of message
do {
    $input = “”;
    $input = socket_read($client, 1024);
    $data .= $input;
} while($input != “”);
// parse data to extract variables
$obj = json_decode($data, true);
// store input data in a database
mysql_connect(“201.408.185.132”,$DBserver,$password); // access database server
mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:
http://www.xay.com/perl/site/lib/SOAP/Parser.html
http://publib.boulder.ibm.com/infocenter/tivihelp/v2r1/index.jsp?topic=/com.ibm.IBMDI.d oc/referenceguide295.htm
   and other parser implementations:
http://publib.boulder.ibm.com/infocenter/tivihelp/v2r1/index.jsp?topic=/com.ibm.IBMDI.d oc/referenceguide259.htm
   all of which are hereby expressly incorporated by reference.

In order to address various issues and advance the art, the entirety of this application for Reinforcement Learning Based Machine Asset Planning and Management Apparatuses, Processes and Systems (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Further and to the extent any financial and/or investment examples are included, such examples are for illustrative purpose(s) only, and are not, nor should they be interpreted, as investment advice. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Similarly, descriptions of embodiments disclosed throughout this disclosure, any reference to direction or orientation is merely intended for convenience of description and is not intended in any way to limit the scope of described embodiments. Relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should not be construed to limit embodiments, and instead, again, are offered for convenience of description of orientation. These relative descriptors are for convenience of description only and do not require that any embodiments be constructed or operated in a particular orientation unless explicitly indicated as such. Terms such as “attached”, “affixed”, “connected”, “coupled”, “interconnected”, etc. may refer to a relationship where structures are secured or attached to one another either directly or indirectly through intervening structures, as well as both movable or rigid attachments or relationships, unless expressly described otherwise. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, provisionals, re-issues, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a MRLAPM individual and/or enterprise user, database configuration and/or relational model, data type, data transmission and/or network framework, library, syntax structure, and/or the like, various embodiments of the MRLAPM, may be implemented that allow a great deal of flexibility and customization. For example, aspects of the MRLAPM may be adapted for expert human to machine knowledge transfer (e.g., in financial, legal, medical, technical, etc. fields). While various embodiments and discussions of the MRLAPM have included machine learning and database systems, however, it is to be understood that the embodiments described herein may be readily configured and/or customized for a wide variety of other applications and/or implementations.

What is claimed is:

1. An artificial intelligence-based order optimization recommendation engine generating apparatus, comprising:
at least one memory;
a component collection stored in the at least one memory;
at least one processor disposed in communication with the at least one memory, the at least one processor executing processor-executable instructions from the component collection, the component collection storage structured with processor-executable instructions, comprising:
obtain, via the at least one processor, a machine learning (ML) training request datastructure, in which the ML training request datastructure is structured to specify a set of agent profile datastructures and an agent sample ranking function, in which an agent profile datastructure is structured to specify an agent's episodic holdings, trades and cashflow data at a bucket level for a training period;
determine, via the at least one processor, an agent samples range, in which the agent samples range is structured as a set of subsequences of agents' episodic holdings, trades and cashflow data;
generate, via the at least one processor, a set of inverse reinforcement learning (IRL) training sample datastructures, in which an IRL training sample datastructure is structured to specify a pairwise comparison of rankings of a pair of agents during a subsequence in the set of subsequences as determined using the agent sample ranking function;
determine, via the at least one processor, a reward function structure to use for inverse reinforcement learning;
determine, via the at least one processor, an optimal reward function having the determined reward function structure using an IRL technique on the set of IRL training sample datastructures, in which the optimal reward function is structured to have parameters that keep pairwise agent ranking orders specified in the set of IRL training sample datastructures;
determine, via the at least one processor, an optimal policy using a reinforcement learning (RL) technique and the optimal reward function, in which the optimal policy provides trading recommendations based on current holdings and an order constraint value; and
store, via the at least one processor, an optimal policy datastructure, in which the optimal policy datastructure is structured to specify a set of parameters that define the structure of the optimal policy.

2. The apparatus of claim 1, in which an agent profile datastructure of an agent is structured to correspond to a fund trading profile of a fund.

3. The apparatus of claim 2, in which funds corresponding to the set of agent profile datastructures utilize the same benchmark portfolio as a fund performance benchmark.

4. The apparatus of claim 1, in which an agent's episodic holdings, trades and cashflow data is for an episode length that is one of: a day, a week, a month, a quarter, a year.

5. The apparatus of claim 1, in which a bucket is one of: an individual stock, a sector, a portfolio.

6. The apparatus of claim 1, in which the training period is one of: a month, a quarter, a year, a plurality of years.

7. The apparatus of claim 1, in which the agent sample ranking function is one of: fund return, Sharpe ratio, Sortino ratio.

8. The apparatus of claim 1, in which subsequences in the set of subsequences are structured to have different subsequence lengths.

9. The apparatus of claim 1, in which subsequences in the set of subsequences are structured to have overlapping date ranges.

10. The apparatus of claim 1, in which an IRL training sample datastructure is structured to comprise:
a tuple specifying two agent-subsequence identifiers, and a binary value specifying a pairwise agent ranking order associated with the two agent-subsequence identifiers.

11. The apparatus of claim 1, in which the reward function structure to use for inverse reinforcement learning is a parametric T-REX function.

12. The apparatus of claim 11, in which the parametric T-REX function is structured to have a set of four parameters {ρ, η, ω}.

13. The apparatus of claim 1, in which the IRL technique is T-REX.

14. The apparatus of claim 1, in which the RL technique is G-Learner.

15. The apparatus of claim 1, in which the set of parameters that define the structure of the optimal policy comprises three parameters ũₜ, \tilde{v}ₜ, \tilde{Σ}ₚ.

16. An artificial intelligence-based order optimization recommendation engine generating processor-readable, non-transient medium, the medium storing a component collection, the component collection storage structured with processor-executable instructions comprising:
obtain, via the at least one processor, a machine learning (ML) training request datastructure, in which the ML training request datastructure is structured to specify a set of agent profile datastructures and an agent sample ranking function, in which an agent profile datastructure is structured to specify an agent's episodic holdings, trades and cashflow data at a bucket level for a training period;
determine, via the at least one processor, an agent samples range, in which the agent samples range is structured as a set of subsequences of agents' episodic holdings, trades and cashflow data;
generate, via the at least one processor, a set of inverse reinforcement learning (IRL) training sample datastructures, in which an IRL training sample datastructure is structured to specify a pairwise comparison of rankings of a pair of agents during a subsequence in the set of subsequences as determined using the agent sample ranking function;
determine, via the at least one processor, a reward function structure to use for inverse reinforcement learning;
determine, via the at least one processor, an optimal reward function having the determined reward function structure using an IRL technique on the set of IRL training sample datastructures, in which the optimal reward function is structured to have parameters that keep pairwise agent ranking orders specified in the set of IRL training sample datastructures;
determine, via the at least one processor, an optimal policy using a reinforcement learning (RL) technique and the optimal reward function, in which the optimal policy provides trading recommendations based on current holdings and an order constraint value; and
store, via the at least one processor, an optimal policy datastructure, in which the optimal policy datastructure is structured to specify a set of parameters that define the structure of the optimal policy.

17. An artificial intelligence-based order optimization recommendation engine generating processor-implemented system, comprising:
means to store a component collection;
means to process processor-executable instructions from the component collection, the component collection storage structured with processor-executable instructions including:
obtain, via the at least one processor, a machine learning (ML) training request datastructure, in which the ML training request datastructure is structured to specify a set of agent profile datastructures and an agent sample ranking function, in which an agent profile datastructure is structured to specify an agent's episodic holdings, trades and cashflow data at a bucket level for a training period;
determine, via the at least one processor, an agent samples range, in which the agent samples range is structured as a set of subsequences of agents' episodic holdings, trades and cashflow data;
generate, via the at least one processor, a set of inverse reinforcement learning (IRL) training sample datastructures, in which an IRL training sample datastructure is structured to specify a pairwise comparison of rankings of a pair of agents during a subsequence in the set of subsequences as determined using the agent sample ranking function;
determine, via the at least one processor, a reward function structure to use for inverse reinforcement learning;
determine, via the at least one processor, an optimal reward function having the determined reward function structure using an IRL technique on the set of IRL training sample datastructures, in which the optimal reward function is structured to have parameters that keep pairwise agent ranking orders specified in the set of IRL training sample datastructures;
determine, via the at least one processor, an optimal policy using a reinforcement learning (RL) technique and the optimal reward function, in which the optimal policy provides trading recommendations based on current holdings and an order constraint value; and
store, via the at least one processor, an optimal policy datastructure, in which the optimal policy datastructure is structured to specify a set of parameters that define the structure of the optimal policy.

18. An artificial intelligence-based order optimization recommendation engine generating processor-implemented process, including processing processor-executable instructions via at least one processor from a component collection stored in at least one memory, the component collection storage structured with processor-executable instructions comprising:
obtain, via the at least one processor, a machine learning (ML) training request datastructure, in which the ML training request datastructure is structured to specify a set of agent profile datastructures and an agent sample ranking function, in which an agent profile datastructure is structured to specify an agent's episodic holdings, trades and cashflow data at a bucket level for a training period;
determine, via the at least one processor, an agent samples range, in which the agent samples range is structured as a set of subsequences of agents' episodic holdings, trades and cashflow data;
generate, via the at least one processor, a set of inverse reinforcement learning (IRL) training sample datastructures, in which an IRL training sample datastructure is structured to specify a pairwise comparison of rankings of a pair of agents during a subsequence in the set of subsequences as determined using the agent sample ranking function;
determine, via the at least one processor, a reward function structure to use for inverse reinforcement learning;
determine, via the at least one processor, an optimal reward function having the determined reward function structure using an IRL technique on the set of IRL training sample datastructures, in which the optimal reward function is structured to have parameters that keep pairwise agent ranking orders specified in the set of IRL training sample datastructures;
determine, via the at least one processor, an optimal policy using a reinforcement learning (RL) technique and the optimal reward function, in which the optimal policy provides trading recommendations based on current holdings and an order constraint value; and
store, via the at least one processor, an optimal policy datastructure, in which the optimal policy datastructure is structured to specify a set of parameters that define the structure of the optimal policy.
